(19) United States
(12) Patent Application Publication
(10) Pub. No.: US 2026/0100660 A1
(43) Pub. Date: Apr. 9, 2026

(54) PROPULSION SYSTEM, INERTIA ATTENUATOR AND FORCE FIELD GENERATOR

(71) Applicant: Alexandre TIAGO BAPTISTA DE ALVES MARTINS, Brasília (BR)

(72) Inventor: Alexandre TIAGO BAPTISTA DE ALVES MARTINS, Brasília (BR)

(21) Appl. No.: 19/347,453

(22) Filed: Oct. 1, 2025

Related U.S. Application Data
(63) Continuation-in-part of application No. 18/225,066, filed on Jul. 21, 2023, now abandoned.
Application No. 18/225,066 is a continuation-in-part of application No. PCT/BR2022/050014, filed on Jan. 18, 2022.

(30) Foreign Application Priority Data
Jan. 22, 2021 (BR) 1020210012668

(51) Int. Cl. H02N 11/00

(52) U.S. Cl. CPC H02N 11/006

(57) ABSTRACT

The present invention relates to a new form of air, land, underwater or space propulsion achieved by the use of suitable electromagnetic interactions. By using capacitors formed by symmetric or asymmetric conductors (1) and (2), surrounded by a dielectric (3), subjected to asymmetric voltage pulses or with asymmetric electric field derivative we obtain directional propulsion forces. This is possible due to a new electromagnetic propulsion mechanism that uses conservation of total momentum where the sum of the mechanical momentum with the electric field momentum should always be conserved resulting in a constant and zero total sum of the two components, where the change in electric field momentum will generate a corresponding change in the mechanical momentum of the capacitor thus generating propulsion forces where the inertia forces are attenuated and can generate force fields.

### BACKGROUND OF THE INVENTION

The present invention relates to a propulsion system based on a new form of propulsion that can be used in air, land, submarine or space, with attenuation of inertial forces and generation of force fields, achieved by the use of suitable electromagnetic interactions that will be explained below.

Recent experiments with symmetrical and asymmetrical capacitors immersed inside vacuum chambers or subjected to the atmosphere but surrounded by a protective dielectric have shown the existence of a new type of electromagnetic propulsion. This is possible due to the conservation of total momentum where the sum of the mechanical momentum and the electric field momentum should always be conserved resulting in a constant and zero total sum of the two components, where the change in electric field momentum will generate a corresponding change in the mechanical momentum of the capacitor thus generating propulsion forces.

As prior art of capacitor propulsion we refer to two patents developed by Thomas Townsend Brown. In the first, capacitors are used that are subjected to static voltages without variations or oscillations (UK Patent 300,311, 1927), where propulsion would always be generated in the direction of the positive pole of the capacitor. In the second patent (U.S. Pat. No. 3,187,206, 1965) it is described how asymmetrical capacitors with the conductors subjected to the atmosphere and fed by static or alternating sinusoidal voltage signals generate propulsion in the direction opposite to the spatial asymmetry of the electric field or asymmetry of the dielectric. The current state of the art regarding inertialess propulsion is given by U.S. Pat. No. 10,144,532 (2018) by Salvatore Cezar Pais. This patent describes a propulsion system that uses microwaves to increase the rotational or vibrational energy of an electrically charged metal surface.

The propulsion systems proposed in the present patent application using capacitors represent a significant improvement over Townsend Brown's prior art using simpler systems than those described by Salvatore Pais. We will move on to describing how the propulsion, inertial attenuation, and force field generation systems of the present technology work.

### DESCRIPTION OF THE CONCEPT BEHIND THE INVENTION

When the atoms of a dielectric material are subjected to an external electric field, they acquire an electric potential energy density Uₚₑ given by:

$${U}_{pe} = - P \cdot E [ J / {m}^{3} ] \qquad ( 1 )$$

Where E is the applied external electric field and P is the atomic polarization vector of a linear dielectric:

$$P = {ε}_{0} {χ}_{e} E = {ε}_{0} ( {ε}_{r} - 1 ) E \qquad ( 2 )$$

With susceptibility χₑ, vacuum permittivity so and relative electrical permittivity εᵣ. The electric energy density U_{E}, taking into account the polarization effects of matter is:

$${U}_{E} = \frac{E \cdot D}{2} [ \frac{J}{{m}^{3}} ] \qquad ( 3 )$$

Which can be rewritten as

$${U}_{E} = - \frac{E \cdot ( {ε}_{0} E + P )}{2} = - \frac{1}{2} [ {ε}_{0} E \cdot E + E \cdot P ] [ \frac{J}{{m}^{3}} ] \qquad ( 4 )$$

This equation represents the sum of the electric energy densities in vacuum and in the interior of matter. This energy is negative for attracting systems like capacitors. The time variation of the energy density ∂U_{E}/∂t will be:

$$\frac{\partial {U}_{E}}{\partial t} = - \frac{1}{2} \frac{\partial }{\partial t} [ {ε}_{0} E \cdot E + E \cdot P ] = - {ε}_{0} E \cdot \frac{\partial E}{\partial t} - E \cdot \frac{\partial P}{\partial t} [ \frac{J}{{m}^{3}} \frac{1}{s} ] \qquad ( 5 )$$

The relationship between linear momentum p_{fields} and energy u_{fields} for electromagnetic fields is given by (Alonso, M., and Finn, E. J., Fundamental University Physics, Volume 2—Fields and Waves, Addison-Wesley Publishing Company, 1967):

$${p}_{fields} = \frac{{u}_{fields}}{c} [ kg \cdot m \cdot {s}^{- 1} ] \qquad ( 6 )$$

Where c is the propagation speed of electromagnetic fields or waves. The last equation for the linear momentum of electromagnetic fields uses the equivalence between energy and matter given initially by Einstein. Full conservation of momentum between fields (p_{fields}) and matter (pₘₐₜₜₑᵣ) requires that:

$${p}_{matter} + {p}_{fields} = 0 ⇒ {p}_{matter} = - {p}_{fields} = - \frac{1}{c} {u}_{fields} [ kg \cdot m \cdot {s}^{- 1} ] \qquad ( 7 )$$

By Newton's laws, the force is proportional to the temporal variation of the linear momentum, providing the following equation for the force density:

$${f}_{matter} = \frac{{dP}_{ma tter}}{dt} = - \frac{{dP}_{fields}}{dt} = - \frac{1}{c} \frac{{dU}_{fields}}{dt} [ \frac{N}{{m}^{3}} ] \qquad ( 8 )$$

Where fₘₐₜₜₑᵣ is the force density developed in matter, pₘₐₜₜₑᵣ is the linear momentum density of matter, p_{fields} is the linear momentum density of fields, and U_{fields} is the energy density of fields. We take the approximation of holding the speed of light constant. Equation (8) represents the total balance between force densities that must exist due to the conservation of the total linear momentum between the considered matter and the fields, that is:

$$\frac{{dP}_{matter}}{dt} + \frac{{dP}_{fields}}{dt} = 0 [ \frac{N}{{m}^{3}} ] ⇒ \frac{{dP}_{matter}}{dt} + \frac{1}{c} \frac{{dU}_{fields}}{dt} = 0 [ \frac{N}{{m}^{3}} ] \qquad ( 9 )$$

For electric fields applied to capacitors, using Equations (1) and (4), the linear momentum density of the electric field P_{E} in the capacitor can be written as:

$${P}_{E} = \frac{{U}_{E}}{c} = \frac{E \cdot D}{2 c} = - \frac{{ε}_{0}}{2 c} E \cdot E - \frac{{ε}_{0} ( {ε}_{r} - 1 )}{2 c} E \cdot E \qquad ( 10 )$$

Where we use the definition of the polarization vector as given in Equation (2), and also that the interaction potential energy is negative for dielectrics subjected to electric fields, as shown in Equation (1). This negative momentum means that the electric field momentum is directed in the opposite direction to the applied electric field vector, as also confirmed by experimental observations. From Equations (8) and (10), the electrical displacement force becomes:

$${f}_{matter} = \frac{{dP}_{matter}}{dt} = - \frac{{dP}_{E}}{dt} = \frac{{ε}_{0}}{c} E \cdot \frac{\partial E}{\partial t} + \frac{E}{c} \cdot \frac{\partial P}{\partial t} = \frac{{ε}_{0}}{c} E \cdot \frac{\partial E}{\partial t} + \frac{E}{c} \cdot {J}_{P} [ \frac{N}{{m}^{3}} ] \qquad ( 11 )$$

Where Jₚ is the displacement current density:

$${J}_{p} = ( {ε}_{r} - 1 ) {ε}_{0} \frac{\partial E}{\partial t} = \frac{\partial P}{\partial t} \qquad ( 12 )$$

Considering the volume dielectric Vₒₗ between opposite poles of the capacitor, the force Fₘₐₜₜₑᵣ developed by each asymmetric pulse will be given by:

$${F}_{matter} = {V}_{ol} \sqrt{{ε}_{r} {μ}_{r}} ( \frac{{ε}_{0}}{c} E \cdot \frac{\partial E}{\partial t} + \frac{E}{c} \cdot \frac{\partial P}{\partial t} ) [ N ] \qquad ( 13 )$$

Where we add the term \sqrt{εᵣμᵣ} due to the change in the speed of light inside the dielectric. The variable μᵣ represents the relative magnetic permeability of the material placed between opposite poles of the capacitor. Equation (13) also includes forces related to the variation of the Polarization P (Equation (2)) of the used dielectric material, that is, it includes variations in time of two different variables: both the applied electric field E and the relative electric permittivity εᵣ of the used dielectric. Using Equation (2) in Equation (13), we can also write that:

$$\frac{E}{c} \cdot \frac{\partial P}{\partial t} = {ε}_{0} \frac{E}{c} \cdot \frac{\partial [ ( {ε}_{r} - 1 ) E ]}{\partial t} .$$

Therefore, in the final calculation of the force in Equation (13), we will have to consider the time-changing effects of both the electric field E and the relative electric permittivity εᵣ. In this way the advantages of using dielectric materials 3 where the relative electric permittivity varies in time in synchrony with the applied electric field (nonlinear dielectrics) become clear.

Equation (13) is the basic and most important equation that describes the functioning of the present propulsion system. The total magnitude of the generated force will scale with the applied pulse repetition frequency of the pulses as described next. The transient mechanical forces developed by Equation (13), commonly referred to as impulse forces (occurring in short time instants) can be described by the following equation: I=∫F·dt, where I is the impulse (N·s), F is the force (N), and dt is the time(s) of actuation of the force F. The impulse has the following form: I=Δp=(mv_{f}−mvᵢ)+(vm_{f}−vmᵢ)=m(v_{f}−vᵢ)+v(m_{f}−mᵢ), where p is the mechanical momentum, m is the mass, v_{f} is the final velocity, vᵢ is the initial velocity, m_{f} is the final mass, and mᵢ is the initial mass. Conservation of linear mechanical momentum tells us that if an object loses mass in a given direction a force will be generated that changes its velocity v_{f} in the opposite direction, gaining the object mechanical momentum in the process.

In a graph of this impulsive force as a function of time we find that the impulse of this force will be given by the integral of the area under the curve of the impulsive force between the initial and final time instants. If we have more than one impulse per second, the total impulse will be the sum of the surface area or integral under each force curve as a function of time. This necessarily implies that the total force will be directly proportional to the number of pulses per second.

In simple mathematical terms suppose that the capacitor generates an average impulsive force F₁, according to Equation (13), during the time interval t₁, so that the Impulse I₁ and corresponding change in linear momentum Δp₁ are given by: I₁=Δp₁=F₁·t₁. This approximation is valid if we consider that F₁ is the average force generated by a single force impulse. In this way, the force generated will be given by:

$${F}_{1} = \frac{Δ {p}_{1}}{{t}_{1}} = \frac{{I}_{1}}{{t}_{1}} .$$

Let us now consider that three asymmetric pulses of equal characteristics to the initial example are applied in succession over the interval of one second. In this case the total impulse I_{T} and corresponding change in total linear momentum Δp_{T} will be given by: I_{T}=Δp_{T}=F₁·t₁+F₁·t₁+F₁·t₁=3F₁·t₁, i.e., by applying three asymmetric pulses in less than one second we can triple the total impulse generated, as well as triple the total change in linear momentum, propelling the capacitor to a final velocity that is three times the final velocity achieved using a single asymmetric pulse. Continuing the development of the last equation and considering that the total force F_{T} developed is given by F_{T}=3F₁, we obtain:

$${F}_{T} = 3 {F}_{1} = \frac{{I}_{T}}{{t}_{1}} = \frac{Δ {p}_{T}}{{t}_{1}} ,$$

that is, the total force felt by the object due to the application of three equal force pulses in less than one second generates a total force three times the force of a single pulse.

In this way, the total force resulting from the repetitive application of several impulsive forces such as that of Equation (13) in a short period of time generates a sum of the applied forces. Illustratively, if a single asymmetrical voltage pulse (decay of −40 kV in 20 ns) generates a force of 2 mN, then if we apply 10⁷ asymmetrical pulses per second, the total force generated will be 20 kN. Since the current state of the technology allows the application of pulses above 100 kV with decays below ns at frequencies above Ghz the applications of propulsion and protective shielding are apparent. In this way we can generate forces of varying total magnitude using the same physical system with a capacitor or system of capacitors. This increase in total force in direct proportion to the number of pulses applied per second was observed experimentally as discussed later in more detail.

The second term in Equation (13) represents the time version of Kelvin's electric gradient force equation f_{KE}, given by:

$${f}_{KE} = P \cdot ∇ E [ N / {m}^{3} ] \qquad ( 14 )$$

Where dielectrics are attracted in the direction of the gradient of applied external electric fields. Using the equation for the propagation of electric fields in space:

$${∇}^{2} E = {ε}_{0} {μ}_{0} \frac{{\partial }^{2} E}{\partial {t}^{2}} = \frac{1}{{c}^{2}} \frac{{\partial }^{2} E}{\partial {t}^{2}} \qquad ( 15 )$$

And if we square root this last equation, we get:

$$∇ E = \pm \frac{1}{c} \frac{\partial E}{\partial t} \qquad ( 16 )$$

Which gives us the spatial gradient of the electric field in terms of the temporal variation of the field and its velocity. By substituting Equation (16) into Equation (14), we recover a simplified version of the electric displacement force density f_{DE}, as given by the second term in Equation (13):

$${f}_{DE} = \frac{P}{c} \cdot \frac{\partial E}{\partial t} = {ε}_{0} ( {ε}_{r} - 1 ) \frac{E}{c} \cdot \frac{\partial E}{\partial t} [ N / {m}^{3} ] \qquad ( 17 )$$

This equation is simply a time variation (never before developed in these terms) of a long known equation, where forces are developed in dielectrics due to the spatial gradient of the electric field generated in our case by the asymmetric time variation of electric fields.

This result is further confirmation of the momentum associated with the electric field in the direction opposite to the electric vector, confirming our initial derivation, Equation (13), in terms of the conservation of field energy and total conservation of the sum of the mechanical and field momentum.

Equations (11) and (13), denote an electrical displacement and polarization force acting on capacitors, which is completely electrical in origin. However, when we adopt the perspective given by the conservation of total momentum we see that this force is generated by interaction with the momentum of space-time itself, which we consider to be equivalent to the momentum of the electric field. From this perspective, this force could also be called “space bending” or “space warping” force, due to the direct interaction with space-time and its deformation, i.e. change in its momentum. Later on, we will clarify this link more clearly.

If the initial and final electric field derivatives are symmetric, then no force will be generated. Equation (13) only develops directional forces when the derivative of E·∂E/∂t is asymmetric. Equation (13) is unique because it is directly proportional to E·∂E/∂t, not requiring time integration as done for Lorentz forces and others that are initially formulated in steady state.

A major advantage of the electric displacement, or polarization, or “space bending/warping” force is that the shorter the applied pulse, the stronger the force generated, due to the fact that it is a time-dependent force where the momentary gradient of the electric field propagated in the dielectric increases with the asymmetric time change of the pulse. Thus, the propagation of a single (E·∂E/∂t asymmetric pulse) of longitudinal electric field will directly generate the force given by Equation (13).

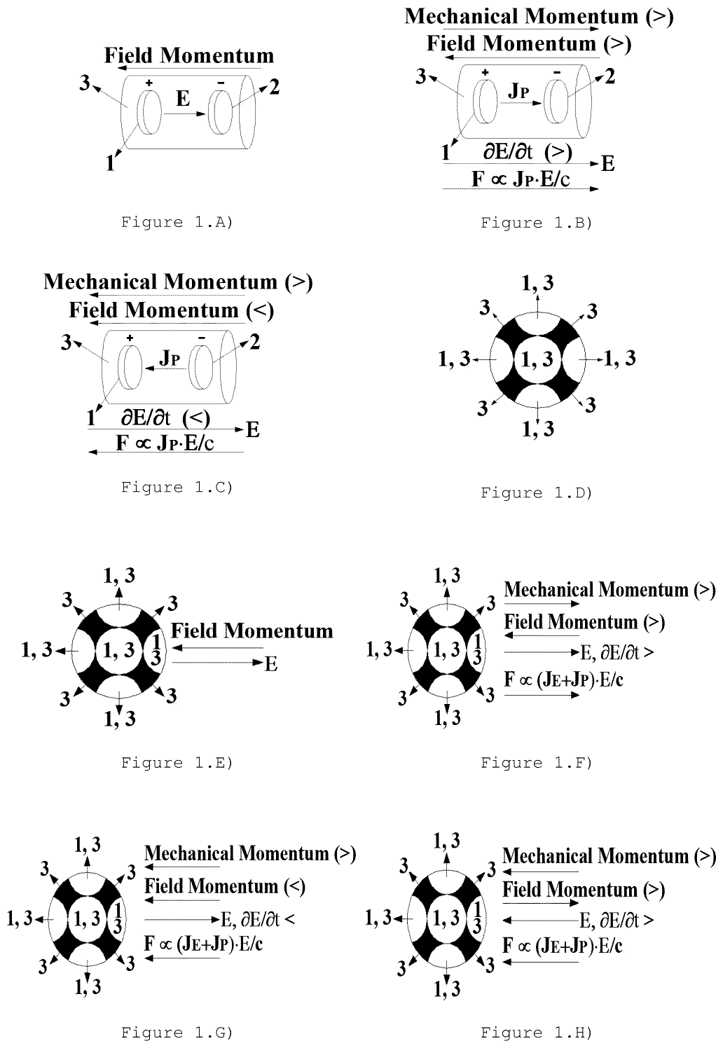

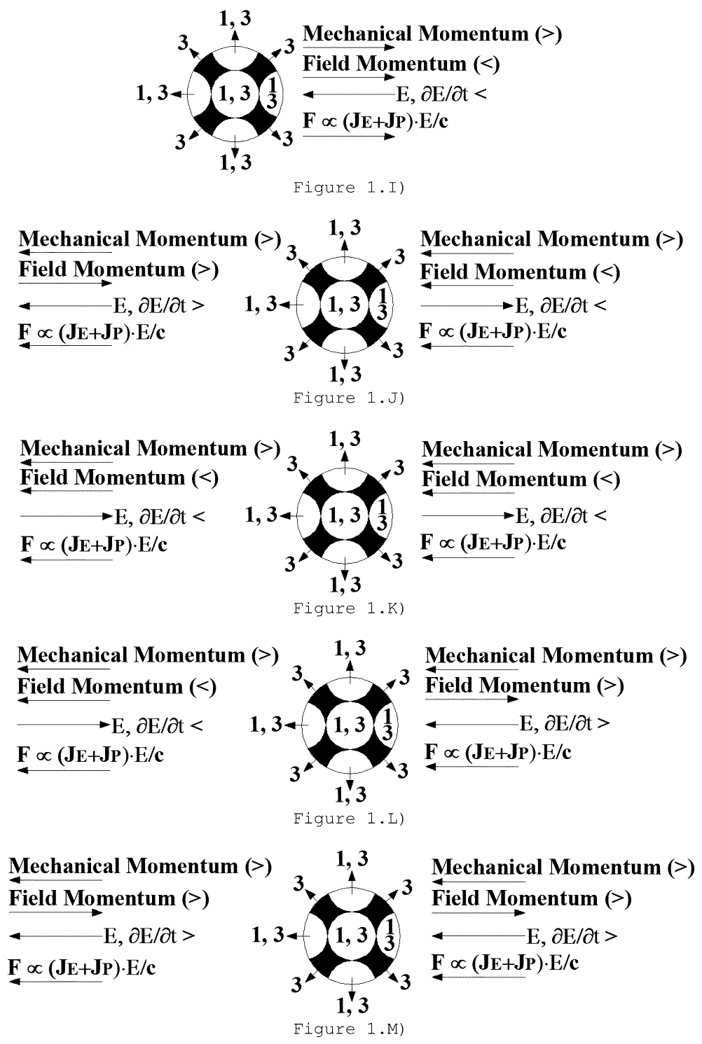

Considering a capacitor formed by a first conductor 1 and a second conductor 2, separated or surrounded by a dielectric 3, discharged initially with zero mechanical and field momentum, and if we charge it, then it will gain electric field momentum in the direction opposite to the electric field vector E, i.e., directed from the ground/negative to the positive electrode (FIG. 1.A). During the charging process of the capacitor, it will gain a mechanical linear momentum opposite to the applied field linear momentum (so that the total sum of the momentum and its variation is zero), with direction from the positive electrode to the ground/negative electrode, generating a mechanical force on the capacitor proportional to the time variation of the electric field momentum as it charges (FIG. 1.B)).

Let us now consider a capacitor that is already electrically charged and has linear field momentum (FIG. 1.A), and zero mechanical momentum. If now the capacitor is discharged then the electric field momentum decreases to zero and the capacitor acquires the momentum lost by the field, gaining mechanical momentum in the same direction as the electric field momentum vector (FIG. 1.C). This process again reflects the conservation of momentum by equalizing the lost field momentum to the gained mechanical momentum of the initial momentum that was present in the field. In this way, we have conservation of total linear momentum by the dynamic exchange of linear momentum between physical matter and the fields, generating mechanical forces on the capacitor proportional to the rate of change of field momentum. If we exchange the solid dielectric for air or vacuum equivalent forces given by Equation (13) will still act.

Using properly constructed asymmetric voltage pulses (with asymmetric V·∂V/∂t or E·∂E/∂t) applied to the capacitor, we are able to generate directional forces in either of two directions longitudinal to the electric field, the magnitude of which increases with the frequency of the applied pulses as noted earlier. Note that the capacitor represented in FIGS. 1.A to 1.C is completely encapsulated by a dielectric 3, as expected for operation in the atmosphere in order to avoid uncontrolled discharges between the capacitor conductors. The theory developed here is valid for any type of capacitor, including symmetrical or asymmetrical capacitors (one of the electrodes having a different size or shape than the other).

When the first conductor 1 is used on the periphery or exterior or external surface of a vessel, Equation (13) also shows how capacitors formed by a single first conductor 1, flat or curved, surrounded or not by a solid dielectric 3 (FIG. 1.D), can move by the emission of electric fields from its surface in a given direction, due to the conservation of the total momentum between the fields and matter. In this case, the forces generated are independent of the use of a first conductor 1 in conjunction with a “physical” second conductor 2, due to the capacitive interaction that the external conductor 1 has with its external environment which in this case is the second conductor 2 because it behaves like a “virtual” second conductor 2. In this way we can also generate propulsion forces if we electrically excite or use only the outer first conductor 1 and subject it to asymmetric V·∂V/∂t or E·∂E/∂t waveforms. Here we assume the internal fields to the sphere are null due to Faraday cage type effects. Let us consider a metallic sphere of Cₛₚₕₑᵣₑ capacitance given by:

$${C}_{sphere} = 4 {πε}_{0} {ε}_{r} R \qquad ( 18 )$$

Where εᵣ is the relative dielectric constant of the dielectric surrounding the exterior of the sphere and R is the radius of the sphere. The total energy of this sphere u_{E} will depend on the voltage V applied to its surface:

$${u}_{E} = \frac{1}{2} \frac{{Q}^{2}}{{C}_{sphere}} = \frac{1}{2} \frac{{( {C}_{sphere} V )}^{2}}{{C}_{sphere}} = \frac{1}{2} {C}_{sphere} {V}^{2} = - 2 {πε}_{0} {ε}_{r} {RV}^{2} [ J ] \qquad ( 19 )$$

Where Q is the electric charge on the surface of the sphere and the negative sign at the end appears due to the negative potential interaction energy for dielectrics subjected to electric fields, Equation (1). The sphere energy provided by Equation (19) already includes the volume integration of the electric fields emitted by the sphere surface in space, and the energy distribution is symmetric and uniform around the sphere in all directions along the electric field lines, according to Equation (4). If we now electrically pulse the surface of this sphere uniformly, then no force would be developed due to the symmetry of the force vectors in all directions. If, however, we can electrically pulse only a single individual section of this sphere, then directional forces will be developed.

Since we have a spherical 3D symmetry, the perpendicular Cartesian components of the electric field flux and its energy will be equally distributed around an imaginary cube with 6 sides that surrounds the sphere, representing all six possible perpendicular directions for the propagation of the electric field flux and energy from the symmetric sphere. Thus, the energy emitted by only one of the perpendicular Cartesian components, for example in the direction of the positive x-axis, will be:

$${u}_{Ex} = \frac{1}{6} {u}_{E} = - \frac{π}{3} {ε}_{0} {ε}_{r} {RV}^{2} [ J ] \qquad ( 20 )$$

We will consider that the metal sphere is decomposed into six different conductive or metallic sections 1 insulated from each other (FIG. 1.D), each corresponding to the six possible perpendicular directions around the sphere, each having one-sixth of the total capacitance of the sphere and emitting one-sixth of the total energy of the sphere in a given direction. If we now electrically excite only one of the six different possible sections, with a constant voltage, electric energy will be emitted only in one direction with electric field momentum p_{Ex} given by:

$${p}_{Ex} = \frac{{u}_{Ex}}{c} = - \frac{π}{3 c} {ε}_{0} {ε}_{r} {RV}^{2} [ kg \cdot m \cdot {s}^{- 1} ] \qquad ( 21 )$$

The direction of the momentum of the electric field will be opposite to the applied electric field vector (FIG. 1.E). We can develop directional forces in matter Fₘₐₜₜₑᵣ using electric displacement forces if we now apply a voltage V pulsed on a metal section:

$${F}_{matter} = \frac{{dp}_{matter}}{dt} = - \frac{{dp}_{Ex}}{dt} = - \frac{1}{c} \frac{\partial {u}_{Ex}}{\partial t} = \frac{2 π}{3 c} {ε}_{0} {ε}_{r} RV \frac{\partial V}{\partial t} = \frac{{C}_{sphere}}{6 c} V \frac{\partial V}{\partial t} [ N ] \qquad ( 22 )$$

When a positive voltage is applied, only to the metallic or conductive section 1 on the right side, with increasing magnitude, the electric field increases (∂E/∂t>) and the displacement electric force will be directed in the direction of the external electric field vector due to the increased electric field momentum opposite the electric field vector (FIG. 1.F). On the other hand, when the voltage and the applied electric fields fall in time (∂E/∂t<), then the developed mechanical force will be directed in the opposite direction of the external electric field vector due to the decrease of the electric field momentum in that direction (FIG. 1.G). The necessary balance between mechanical and electric field momentum, whose sum total and whose total time variation should be zero, Equations (7) and (9), provide the displacement electric forces generated by the conservation of total momentum.

If the derivative of the initial and final V·∂V/∂t or E·∂E/∂t fields are symmetrical, then no force will be generated. Equation (22) only develops directional forces when the derivative of the applied V·∂V/∂t or E·∂E/∂t fields are asymmetric. If in a given positive voltage pulse, the derivative of the first positive voltage increase (“rise time”) is faster than its subsequent decrease (“fall time”), then a force will be generated in the direction of the electric field vector (FIG. 1.F), and if the derivative of the voltage decrease (“fall time”) is faster than its initial increase (“rise time”) derivative, then a force will be generated in the direction opposite to the external electric field vector (FIG. 1.G). The force developed by each asymmetric pulse applied to the considered spherical mass, by applying voltage pulses to one of the six different sections, with capacitance C_{section}, will be given by:

$${F}_{Total} = \sqrt{{ε}_{r} {μ}_{r}} \frac{{C}_{sphere}}{6 c} V \frac{\partial V}{\partial t} = \sqrt{{ε}_{r} {μ}_{r}} \frac{{C}_{section}}{c} V \frac{\partial V}{\partial t} [ N ] \qquad ( 23 )$$

Where we add the term εᵣμᵣ due to the change in the speed of light inside the dielectric, if one is used. As discussed with respect to Equation (13), Equation (23) also includes forces related to the variation in Polarization P of the used dielectric 3. In this case, using Equation (18) we can write that:

$${C}_{sphere} V \frac{\partial V}{\partial t} = 4 {πε}_{0} {ε}_{r} RV \frac{\partial V}{\partial t} = 4 {πε}_{0} RV \frac{\partial ( {ε}_{r} V )}{\partial t} .$$

That is, we again confirm the advantages of using dielectric 3 materials, where the relative electrical permittivity varies in time in synchrony with the applied electric field (nonlinear dielectrics). As discussed in paragraph (19) in relation to Equation (13), the total force developed by Equation (23) will also increase in direct proportion to the number of pulses applied per second.

We have the option of using a pure sphere or metal section 1 without any coating, or the possibility of externally coating the surface of this sphere or section with a dielectric 3, with εᵣ higher or lower than 1, which will allow the generated force to be increased substantially. The addition of magnetic materials inside or outside the dielectric 3 with μᵣ higher or lower than 1 will also increase the generated force. For this reason, the sections of first conductor 1 depicted in FIGS. 1.D through 1.M, are also simultaneously designated by the reference number used for the dielectric 3 due to the optional possibility of first conductors 1 being covered by dielectric 3 or other magnetic materials. On the other hand in these figures the dielectric 3 is also used to separate and laterally isolate each conductive section of first conductor 1, so that each of the sections of first conductor 1 can be individually used and electrically activated.

If we now reverse the polarity of the voltage applied to the metal section 1 to the right of the segmented conducting sphere to the negative, then if the voltage or electric field increases, the force generated will be directed to the left (FIG. 1.H), in the direction of the electric field vector. If the voltage or electric field decreases then the force will be generated to the right (FIG. 1.I), in the direction opposite to the electric field vector. As discussed earlier, when applying a voltage pulse, the total force will be generated in the direction of the major time derivative of the electric field.

There are several possible variations by which we might generate displacement electric forces using pulsed electric fields. Applications with positive or negative pulses on a single metal section 1 have been illustrated in FIGS. 1.F through 1.I. However, the force generated in a given direction can be increased in magnitude if opposite metal sections 1 are electrically excited with the appropriate pulses so as to generate forces in the same direction.

For example, there are four different ways to induce leftward displacement electric forces, which include a) when the electric field increases on the left and decreases on the right (FIG. 1.J), or b) when the electric field decreases on both the left and the right (FIG. 1.K), or c) when the electric field increases on the right and decreases on the left (FIG. 1.L), or d) when the electric field increases on both the left and the right (FIG. 1.M).

As we can see (FIG. 1) the capacitor, composed of one, two or more first conductors 1 and/or second conductors 2, will move in the necessary direction to satisfy the conservation of the total momentum of space-time around it. Let us now explain in more detail the use of the terms “inertia attenuation”, “spatial warp” and “direct action on space-time”. The theory of the present patent application was developed for the explicit purpose of seeking to explain experimental observations of forces in capacitors that occurred without the emission or expulsion of physical matter as occurs in the conventional rocket concept. We note that the force developed in capacitors is due to the asymmetric rate of change of the electric field linear momentum, that is, when the variation of the electric field linear momentum is greater in a given direction, directional mechanical forces will be generated in the capacitor. This observation is also a theoretical necessity, a consequence of the total conservation of momentum when we account for the variation of the mechanical momentum with the electric field momentum. In reality the operation of this system is very similar to that of a conventional rocket, but in this case instead of matter being expelled in a given direction, only energy is expelled. The energy (and its equivalent “mass”) expelled is very small, but this is offset by the speed of propagation of the electrical distortions being the speed of light, and also due to the use of extremely fast rates of temporal variation of the momentum associated with this energy, which for this reason is able to generate relevant observable forces.

In relativity theory, the energy-momentum tensor of space-time from which “space fold/warp” distortions are achieved considers space-time to be a kind of perfect fluid, the source of gravitational interactions (Gron, O., and Hervik, S., “Einstein's General Theory of Relativity,” Springer Science, 2007; Osvaldo, L. S.-P., et al., “Fluid dynamics in the warp drive spacetime geometry,” Eur. Phys. J. C81, 133, 2021). The theory presented in this patent application expands on the previous concepts by considering that the velocity of space-time or this perfect fluid is proportional to the electric field linear momentum, and that the acceleration of this space-time is proportional to the time variation of the electric field linear momentum. In this way, directional forces will be developed only if the temporal variation of the electric field linear momentum is asymmetric.

As confirmation of this theoretical proposal we have experimental results that only make sense if the linear momentum of space-time, i.e. the velocity state associated with space-time is directly related to the electric field linear momentum and if the acceleration of space-time is associated with the asymmetric variation of the electric field linear momentum. We mention a specific case of application of our experimental observations. In this case, we observed that a capacitor with 5.3 pF of capacitance where −40 kV was applied generates a force of approximately 2 mN when the voltage drops abruptly to zero in about 20 ns, and the linear increase of this force up to 10 mN was observed in direct proportion with the increase in frequency of the asymmetric pulses. This case is merely illustrative to demonstrate that the concept works as described.

In order to facilitate the replication of the experimental observation of displacement electric forces in capacitors by any person skilled in the art, we provide full thruster and setup dimensions and details of our initial experiments, which resulted in very positive experimental confirmation of this new propulsion effect. For our experiments, we used a horizontal cylindrical vacuum chamber with an inside diameter of 1.2 m and a depth of 1.75 m constructed in non magnetic Stainless Steel ISO 304 SS, capable of a vacuum up to 10.7 mbar. Our setup was placed suspended at the center of this vacuum chamber in order to be as far away as possible from the inside of the vacuum chamber walls. We tested symmetric and asymmetric capacitors in a vacuum of 5×10⁻⁵ mbar or lower because the electrodes were exposed to the environment and if used in the atmosphere they would ionize ambient air and generate forces by the known Electrohydrodynamic (EHD) ion wind effect. This ion thrust in the atmosphere generates forces towards the disc in the asymmetric capacitor independently of the applied polarity to the disc, where in the symmetric capacitor these forces tend to be smaller. In EHD systems generally one electrode emits ions (smaller or sharper electrode) and the other collects these ions, where propulsion is observed in the direction from the collector towards the ion emitter. This introduction to EHD systems is important in order to establish a baseline and later compare it with our results. Since the EHD force direction is well established to be in the referred direction in asymmetric capacitors we prefer to provide in more detail the experimental results obtained with this thruster since they conclusively prove more easily that a no conventional force or effect is responsible for the observed forces.

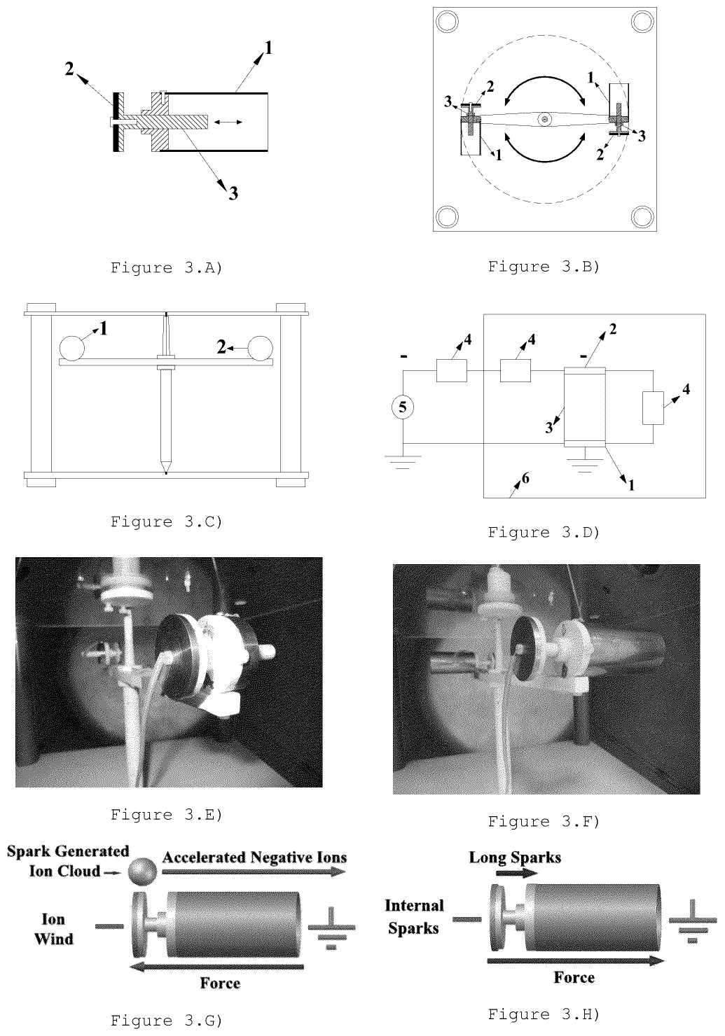

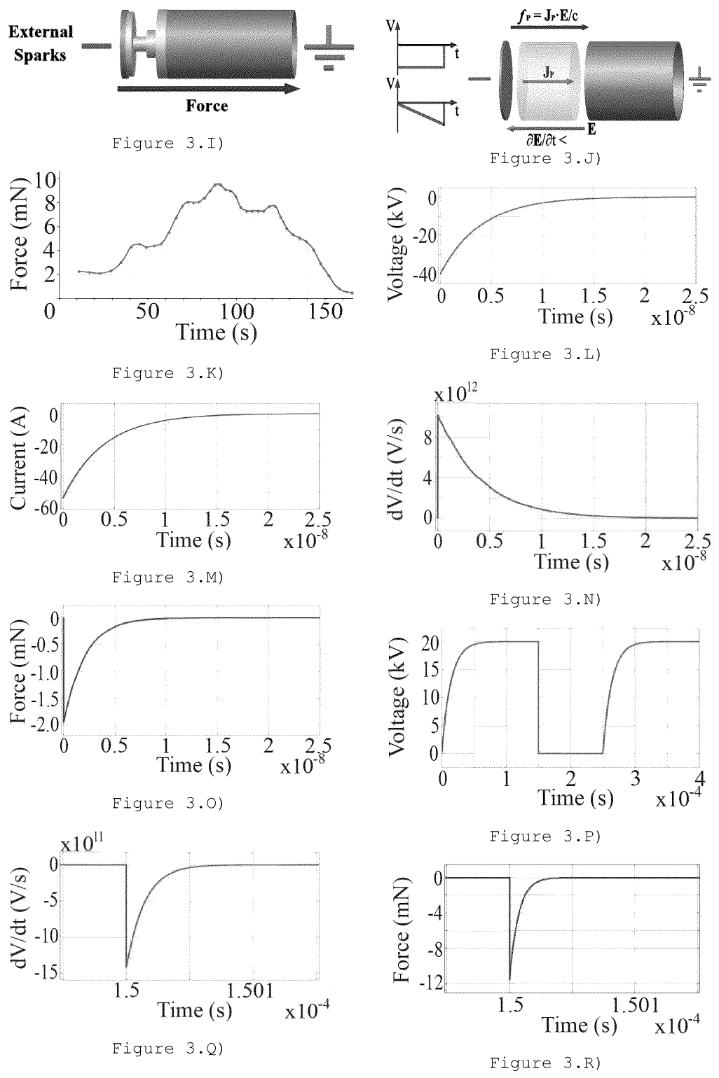

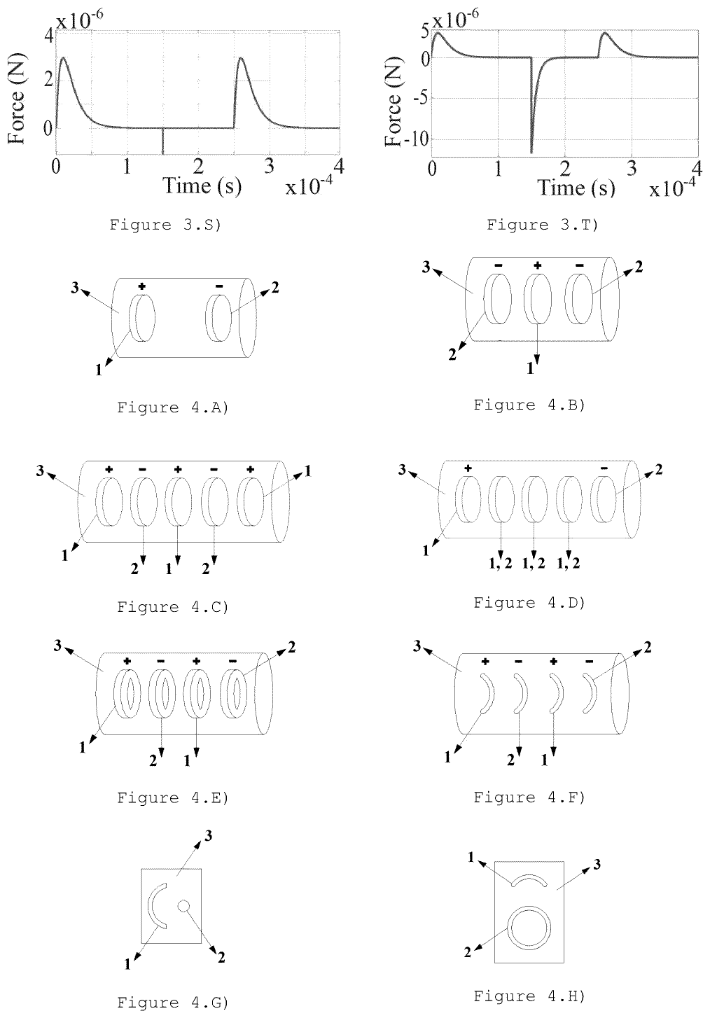

A drawing to scale of the used asymmetric capacitor is provided in FIG. 3.A, where the metal (in black) was brass and the dielectric (diagonal lines) Tecapet. The second conductor 2 or disc at the left (diameter of 3.5 cm, thickness of 3 mm) with the cylinder of dielectric 3 can be moved horizontally in order to change the distance between the second conductor 2 or disk and first conductor 1 or cylinder (length of 6.4 cm, diameter of 3.5 cm and thickness of 1 mm) separated by dielectric 3. These capacitors were designed so that we could change the gap distance between the electrodes from 1.4 cm to 6 cm. The electrical connections to these capacitors were fixed with Nylon screws. We used two equal capacitors placed in both extremities of a horizontal supporting arm so that a rotation of this arm around a vertical axis occurs if a force higher than 0.32 mN is generated. A drawing to scale of the used setup and its structure is provided in FIGS. 3.B and 3.C so anyone can replicate our results. The four vertical supports (diameter of 3.1 cm and total height of 25.8 cm) are just regular gray pvc pipes. The top square support is from transparent acrylic 3 mm thickness and the horizontal arm, vertical axis and lower square support (1 cm thickness) are from (white) Tecapet also, both with dimensions of 40×40 cm. The testing setup with our thrusters are placed inside a vacuum chamber or metallic shield 6 (FIG. 3D), here acting as an enclosure, where the air is taken out to at least 5×10⁻⁵ mbar or lower and the capacitor's second conductor 2 (disc) is subjected to a negative high voltage and the first conductor 1 (cylinder) is connected to ground through a high voltage power supply 5 of the type HIPOTRONICS HD140-B, capable of providing a negative direct current (DC) high voltage up to −40 kV with currents up to 5 mA. A photo of the used symmetric and asymmetric capacitors placed in our setup is provided in FIGS. 3.E and 3.F, respectively.

When the voltage was turned on initially (2.8 cm distance between capacitor electrodes) we observed a high current spark of 4-5 mA magnitude going from the high voltage second conductor 2 (disc) to the nearest side dielectric surface (up to 2.5 mm) generating a bright flash and propulsion from the cylinder to the disc as expected from normal EHD propulsion (FIG. 3.G). We later observed that the dielectric was burned in some specific locations, meaning that the high current spark discharge burned and evaporated the dielectric material propelling it towards the cylinder and generating a motion towards the disc as expected from EHD ion wind operation (FIG. 3.G), generating a top force of around 10 mN in vacuum. This was not desirable so we removed all the burned parts and reduced the diameter of the round dielectric near the disc electrode by 1 mm in order to avoid these direct discharges. We also added a 4 MΩ resistor, acting as a resistive switch 4, between the power supply and the cathode in order to reduce the current and avoid the initial strong discharges. In these conditions, and with a smaller 2.0 cm distance between the capacitor electrodes, we observed that there were several low current spark events in several different points external and internal to the capacitor, but this time the average currents generated were three orders of magnitude lower than before in the range of 4-5 HA. We could observe sliding sparks of the dielectric surface flashover type (known in the literature as “Low Energy Surface Flashovers”) that went occasionally from cathode to ground through the whole capacitor dielectric surface (FIG. 3.H), effectively shorting the capacitor and generating a force moving the capacitor from negative to ground (FIG. 3.H). We have also observed that when only external sparks were at play and rapidly discharged the cathode electrode, strong forces were observed also from cathode to ground (FIG. 3.I). The discharges inside the capacitor this time did not burn the dielectric due to the low current but we measured a force of ˜2 mN generated per each internal discharge event in a direction opposite the EHD usual force. External discharges (to the capacitor) were observed between the high voltage metal contacts and the Tecapet part of the lower base of the vertical rotating axis providing for a discharge path of the capacitor to the Tecapet dielectric. This forms a natural resistive high voltage switch 4 to rapidly discharge the capacitor through the low resistance plasma that is momentarily generated, just like occurs when the capacitor is shorted by an inside low current spark (FIG. 3D). The generated force was observed to vary in magnitude with the internal or external low current discharges per second up to a peak of 10 mN (FIG. 3.K) with a variable random pulse rate of up to 5 discharges per second.

For the ion wind case, the average force was 5.92 mN from the cylinder towards the disc, during a 20 lap run from start to finish while consuming an average of 2.5 mA at 40 kV or ˜100 W. In the external low current discharge case, the average force was 5.65 mN (average of 2.89 pulses per second) during 21 laps from disc to cylinder while consuming an average of 4.5 μA at 40 kV or ˜0.18 W. This later case consumed 555× less power than used in the ion wind case while generating forces of similar magnitude but opposite to the EHD force direction. This result certainly could not be explained by any known science and we took some years of analyzing these results and developed the theory shown above which is a perfect match to explain the observed experimental results. The developed displacement force theory predicts that when a capacitor charged negative DC is abruptly discharged a force is generated from minus to ground or from minus to positive (FIG. 3.J). It was observed that a single voltage decay of ˜20 ns (FIG. 3.L) generates a force of ˜1.95 mN, for a single 5.3 pF capacitor. We have simulated the equations of the theory presented here with voltage decay (FIG. 3.L), current variation (FIG. 3.M), voltage derivative (FIG. 3.N), and force (FIG. 3.O), with the magnitude of the generated force predicted to be ˜1.95 mN per single internal or external capacitor discharge in a vacuum. The graph for the force is highly asymmetrical, that's why we can equate the generated force to the peak of the fastest initial pulse. If the graph for the force were to show a symmetrical rise and decay, then no force would be generated. This corresponds perfectly with what we have observed experimentally and confirms the validity of the developed theory. This theory has been validated experimentally both for the effects of positive or negative voltage variations in symmetric or asymmetric capacitors.

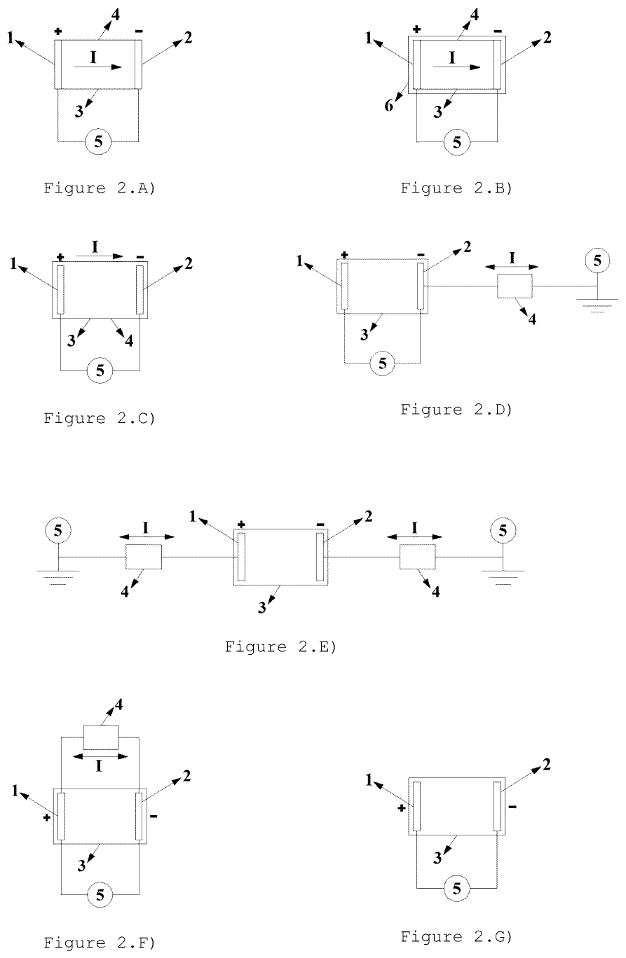

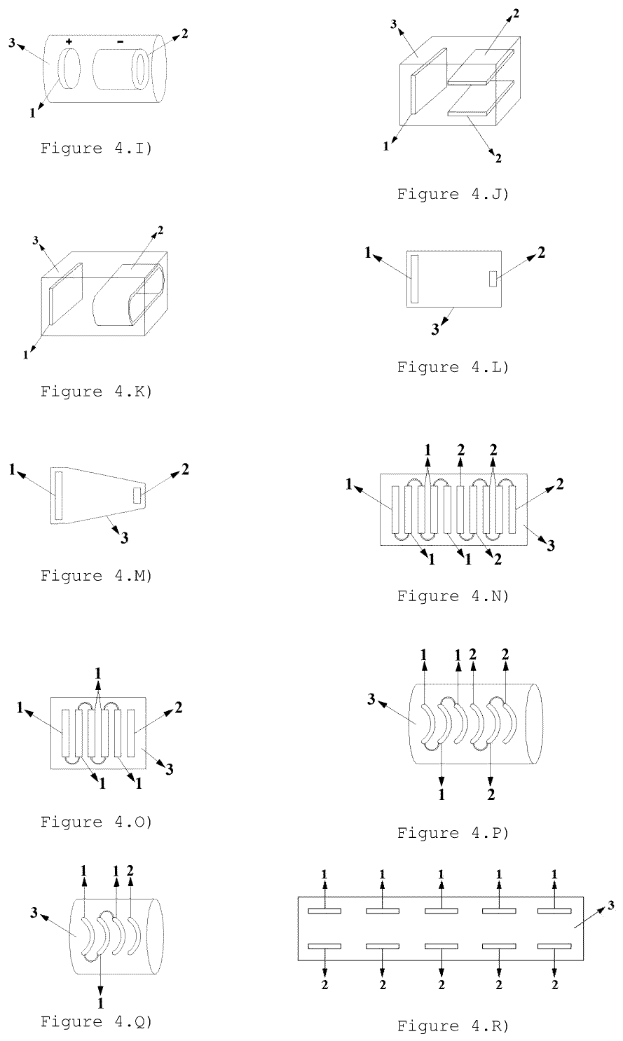

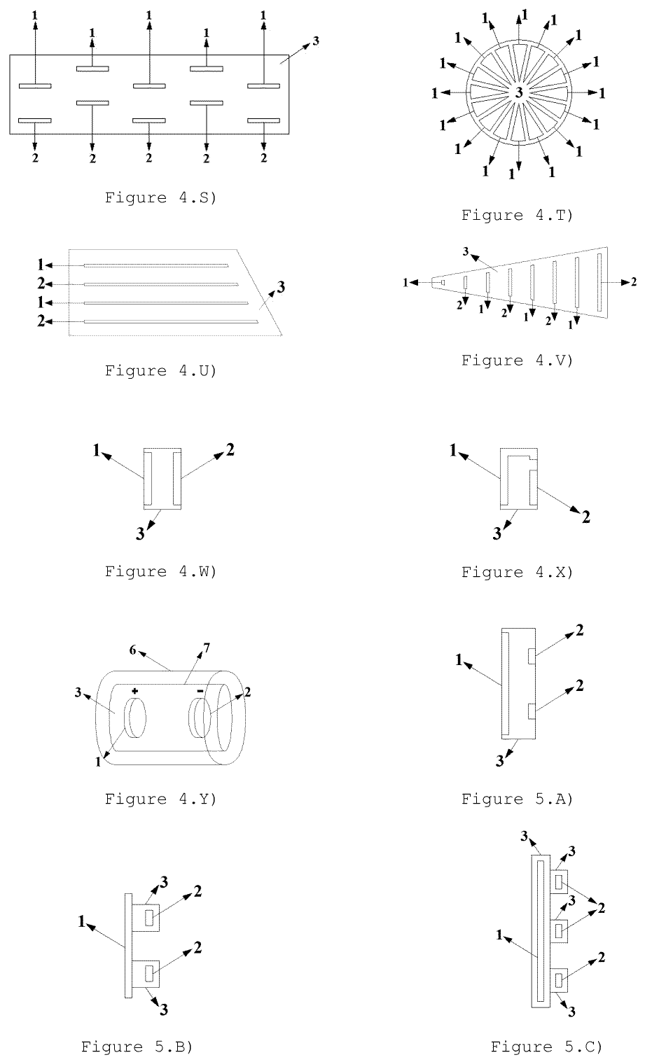

When the capacitor is charging through the 4 MΩ resistor it generates a force of 0.12 mN from cylinder to disc which is much smaller than when the capacitor is discharged through the ˜743.5Ω resistor of the “Low Energy Surface Flashover” in a vacuum. In order to replicate these results in the atmosphere we have to place the capacitor inside a dielectric protection like high voltage epoxy in order to avoid any leakage or ion wind generation, from the capacitor or electrical connections. We have used the same setup (FIGS. 3.B and 3.C) with symmetrical or asymmetrical capacitors protected with epoxy and subjected to the shown voltage pulses (FIGS. 3.L to 3.T) using the circuit of FIG. 2.F with success also. In this case the high voltage power supply 5 was DC up to 100 kV bipolar, the geometry of the tested capacitors was the one shown in FIGS. 4.A (inside epoxy disc of 5.5 cm radius and 1 cm thick), 4.G and 4.H (inside epoxy disc of 5 cm diameter and 1 cm thick), where we have used custom built high voltage spark gaps as high voltage switch 4 in order to rapidly discharge the capacitor, with a variable pulse rate depending on the distance between electrodes in the spark gap and the applied voltage, that was being charged through a 4 MΩ resistor. This setup allowed us to replicate the initial vacuum results in the atmosphere in a simpler and cheaper way while providing further experimental proof of the developed theory to explain the effect and force multiplication with the increase of the pulse repetition frequency.

We will now provide more details of the symmetric capacitor that was tested in order to show how simple it is to replicate this new propulsive effect and also how easy it is to understand how it works according to well established principles of physics. We have used a small symmetric cylindrical capacitor with disc electrodes of 5 cm radius, 2 mm thickness and glass dielectric with relative permittivity of 3.86, 2 mm thickness, capacitance of 140.2 pF and an applied electric potential of 20 kV. At 20 kV this capacitor will have an energy density of 1.27×10³ J/m³, which corresponds to an “electric field mass density” of 2.77×10⁻¹⁴ kg/m³, and an “electric field mass” of 4.35×10⁻¹⁹ kg, which is a very small mass indeed. However, we have the added benefit that electric field disturbances travel at or near the velocity of light. From Equation (10) the total negative electric field momentum P_{E} available for change is −2.61×10⁻¹⁰ kg·m·s⁻¹, pretty small in magnitude also. However, if this small momentum can change fast enough, for example by discharging the capacitor in 22.42 ns, then the force generated becomes 11.63 mN, for that single pulse. If the same original electric field momentum P_{E} changed more slowly by charging the capacitor in 86.80 μs for example, the generated force would then only be 3.00 μN. These force differences corresponds to charging the capacitor through a resistance of 100 kΩ and discharging it through a smaller resistance of 100Ω (FIG. 3.P). When charging the capacitor a 3.00 μN force is obtained as can be seen from the force peak in FIG. 3.S. When the capacitor discharges through a resistance of 100Ω it generates a force of 11.63 mN, identified as the peak of the asymmetric force waveform (FIG. 3.R), which is in the ballpark of the experimentally observed force.

If the capacitor is charged from zero to 20 kV and back to zero with the same charging and discharging times (or with any unipolar rectified symmetric waveforms) a directional force would continue to be generated in a given direction because E·∂E/∂t is smaller when the voltage starts from zero, than when it falls from a given voltage like 20 kV to zero (FIG. 3.T). In the last given example (FIG. 3.T) if the capacitor charges and discharges through a similar 100 kΩ resistor, then charging the capacitor will generate a force of 3.00 μN (from positive to negative) and discharging the capacitor will generate a force of 11.63 μN in the opposite direction, with total resultant of 8.63 μN per pulse or waveform from negative to positive. In this case we would have to use a pulse repetition rate of 1 kHz in order to generate a force of 8.63 mN or 1 MHz to generate 8.63 N and so on until the limit of the waveform timings. As we saw above, when we abruptly discharge the capacitor in 22.42 ns, it generates a force of 11.63 mN. In this case we would have to use a pulse repetition rate of 1 kHz in order to generate a force of 11.63 N or 1 MHz to generate 11.63 kN and so on also until the limit of the waveform timings. Abrupt discharges generate higher forces because in rectified unipolar waveforms there is a bigger opposing force in each waveform but the resultant will always be bigger for the discharging phase which can be compensated by a higher repetition rate of the pulses. When using these rectified unipolar signals the generated force will always be from negative to positive polarity because the discharge phase always generates a stronger E·∂E/∂t. The simulated polarization or displacement force magnitude has a positive value when the capacitor is charging and a negative value when it is discharging (FIG. 3.T). This confirms that the direction of the generated force is in the direction of the applied electric field when the capacitor is charging and in a direction opposite the electric field when it is discharging.

In short, the key factor to generate space drive propulsion forces is to have asymmetric E·∂E/∂t waveforms, and this can be achieved through the use of many waveforms, including rectified symmetric waveforms and highly asymmetric voltage pulses applied to a capacitor. The differences in magnitude for the force generated in each opposite direction are directly proportional to the time rate of change of the electric field momentum and if the capacitor is starting from zero (charging) or from a given voltage (discharging). To our knowledge there is no other theory in the public records that is able to fully describe this new propulsive effect like the one developed here and able to describe how propulsion can be achieved through a variety of different waveshapes that are abruptly pulsed and asymmetric or that are fully symmetric like unipolar (positive or negative) rectified sinusoidal, square or even triangle pulses. The easiest way to replicate this new propulsion effect is to simply charge and discharge a given capacitor with asymmetric charge and discharge times. This can be done by using a high value resistor switch 4 (including or not any other switch 4) for charging the capacitor and a low value resistor switch 4 (including or not any other switch 4) to discharge the capacitor, or inversely, in rapid succession so a higher magnitude force is generated.

It is known from the literature that “space drive”, “warp drive” or “space fold/warp” type thrusters use the matter or energy of spacetime itself as the means of locomotion (Osvaldo, L. S.-P., et al., “Fluid dynamics in the warp drive spacetime geometry,” Eur. Phys. J. C81, 133, 2021). As stated by Campbel (Campbell, J. W., “The space drive problem”, Astounding/Analog (US), pp. 83-106, June 1960) e Clarke (Clarke, A. C., Profiles of the future: An inquiry into the limits of the possible, Harper & Row, New York, 1962): “A space drive is a propulsion mechanism that acts directly upon the fabric of free-space”, that is, the propulsion mechanism associated with the “space drive” acts directly on the free space or space-time factory through a “space fold” or “space warp” or “direct action on space-time”.

It is well known that Einstein showed that an object accelerated by a force originating in space-time such as the gravitational force does not undergo inertial forces (Nobili, A. M., et al., “On the universality of free fall, the equivalence principle, and the gravitational redshift,” Am. J. Phys. 81, 527, 2013). Any object that is accelerated by a gravitational force continues to maintain its inertial mass (inertial mass is not cancelled) but when falling freely into a gravitational field the object will not feel its own weight and will not feel inertial forces. It was this concept that according to Einstein gave rise to his theory of General Relativity as mentioned in the reference above.

The “space drive” and “warp drive” type force discussed above in relation to the theory of the present system has a similar origin to the gravitational force generated by physical masses, although the first is generated by the dynamic fast variation of the energy (and equivalent mass) of electric fields and their energy and “mass” in capacitors as discussed in [056], while the second relies only on the amount of physical mass in a static manner, thereby requiring the use of much more mass in order to have a similar force effect, however, they both act on other masses and generate forces on those masses by direct manipulation of space-time. Einstein's General Theory of Relativity (Gron, O., and Hervik, S., “Einstein's General Theory of Relativity,” Springer Science, 2007) uses Riemann's approach, in purely geometric terms, to explain the origin of gravitational and electromagnetic forces as originating in the deformation of space-time, considering that space-time is curved, manipulated, or distorted by the presence of matter or energy. However, the problem with this approach is that it is purely mathematical without proposing a physical mechanism for how the deformation of space-time takes place. Einstein helped in understanding the problem by suggesting that the warping, bending or curvature of space-time is directly correlated to the presence of energy-matter in that space, E=mc², however Einstein could not explain exactly how mass or electromagnetic interactions are able to warp space-time generating the gravitational and electromagnetic forces (Kaku, M., “Hyperspace,” Oxford University Press, 1994).

The total relativistic energy equation for mass or photons is given by: E²=m₀²c⁴+p²c² (Halliday, D., Resnik, R., and Walker, J., Fundamentals of Physics Extended, 8th Edition, John Wiley & Sons, 2007) where E is the total energy, m₀ is the rest mass, and p is the momentum. The energy of photons or dynamic propagating electromagnetic fields is given by: E_{fields}=p_{fields}c (Alonso, M., and Finn, E. J., Fundamental University Physics, Volume 2—Fields and Waves, Addison-Wesley Publishing Company, 1967), that is, the multiplication of field momentum p_{fields} with the velocity of light c. This equation uses the assumption on the total relativistic energy equation that photons have zero rest mass m₀, because photons are dynamic propagations of electromagnetic fields at the local velocity of light and cannot exist at velocities lower than light. However, from the classical equation above and the definition of momentum (p=mv) we can find an equivalent relativistic mass for the photons. In this case the field momentum is given by known equation:

$${p}_{fields} = \frac{{E}_{fields}}{c} ,$$

and the expelled mass becomes proportional to: m_{relativistic}=p_{fields}/c=E_{fields}/C2=m_{fields}. That is, the equivalent relativistic mass of the photons m_{relativistic} is the same as the mass of the fields m_{fields} in the steady case state. This reflects the conservation of mass between fields in the steady case (no field variation—no photons exist) and fields in the dynamic case (field varies—photons, energy and momentum are emitted).

Inertia exists in all objects that are accelerated by mechanical forces (transmitted between masses by local electromagnetic repulsion forces between the electron clouds of neighboring atoms) and that in their entire volume move “against” space-time and not “by” the deformation of space-time. The theory shown so far shows how it is possible to manipulate the state of velocity and acceleration of space-time itself by the electric field linear momentum and its time variation, being able to generate forces by the asymmetric flow of the variation of the electric field linear momentum in a given direction. In simple terms, this means that a directional flow of energy (or equivalent “matter”, E=mc²) is generated by the asymmetric variation of the electric field linear momentum, that is, a local deformation of space-time will be caused where forces will be generated without inertia only in the volume where the asymmetric flow of energy takes place. In contrast, the ordinary gravitational force is generated by the constant energy gradient (curvature) induced in space-time by the presence of a mass, and therefore it is much less efficient than the current space drive in bending or warping spacetime due to the requirement of having very large masses in order to develop relevant gravitational forces.

This dynamical approach expands Einstein's initial concepts of static energy and mass to manipulate space-time, which were later expanded by him to include gravitational waves generated by the oscillation of matter and which have recently been observed experimentally (Abbott, B. P., et al., “Observation of gravitational waves from a binary black hole merger,” Physical Review Letters 116, 061102, 2016).

Instead of oscillating physical matter, as proposed by Einstein, to generate gravitational waves, the system proposed in this patent application asymmetrically oscillates the energy (and therefore its equivalent mass, m=E/c²) accumulated in the capacitor thus generating asymmetric gravitational waves of small amplitude per asymmetric pulse, but with sufficient intensity to, in conjunction with the increase in the repetition rate of the pulses, generate asymmetric forces of great relevance, with varying magnitude, in the structure of the same.

For this reason, to attenuate or reduce the inertial force on the occupants of a ship or vehicle the deformation of space-time will have to be accomplished using thrusters the size of the ship itself (or using several smaller thrusters with an equal resultant) in order to manipulate the asymmetric flow of energy throughout its volume. If “space drive” or “warp drive” type thrusters are used with a size that is not capable of deforming space-time in the complete volume where inertia needs to be removed, then it will not be affected. In this way, we try to clearly show the physical mechanism and the conditions under which “inertia attenuation” may occur.

As we mentioned at the beginning of this patent application, the state of the art in terms of propulsion with “inertia reduction” is given by the patent: U.S. Pat. No. 10,144,532 B2: Craft using an inertial mass reduction device, 2018. The author of this patent has two published papers (Pais, S., “A hybrid craft using an inertial mass modification device,” AIAA 2017-5343, AIAA Space and Astronautics Forum and Exposition, Orlando FL, Sep. 12-14, 2017; Pais, S., “High Frequency Gravitational Waves-Induced Propulsion,” SAE Technical Paper 2017-01-2040, 2017) where it is illustrated how the term “inertial attenuation” is used within the context of space-time manipulation by electromagnetic systems.

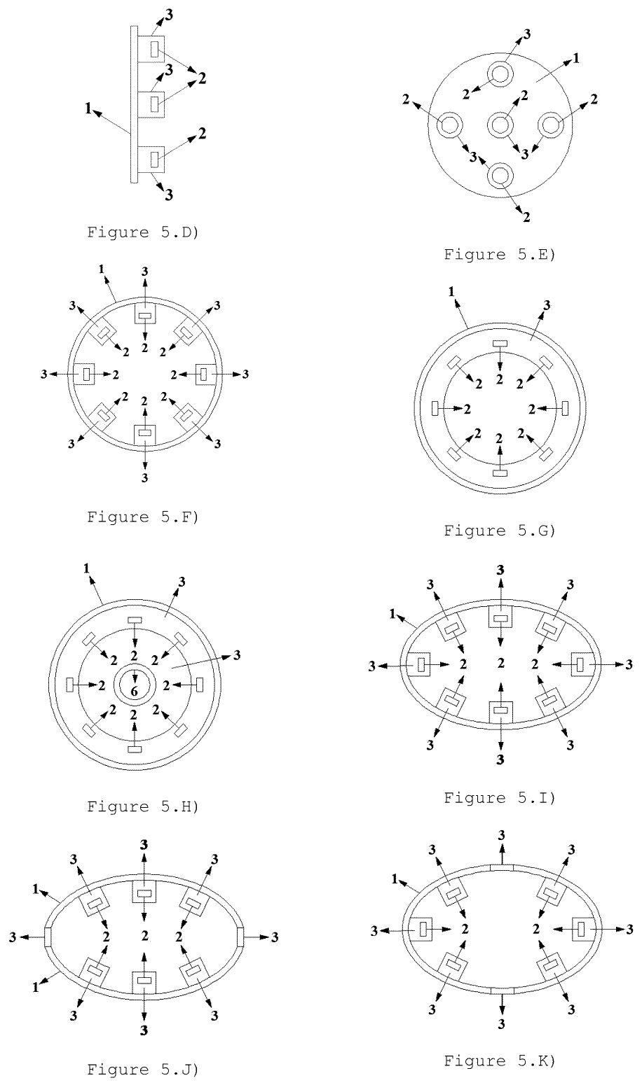

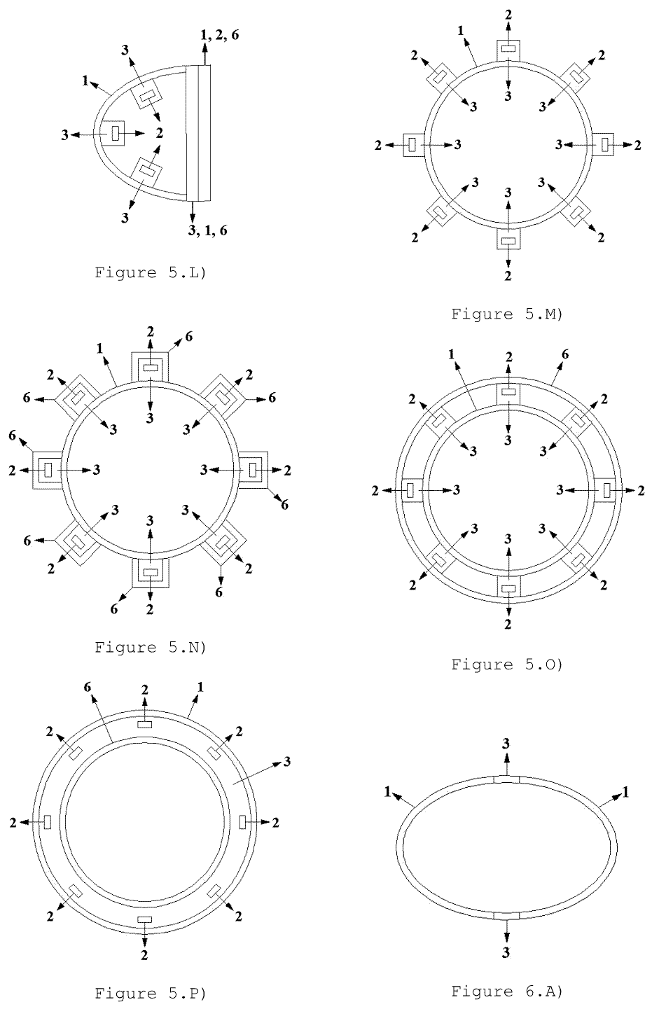

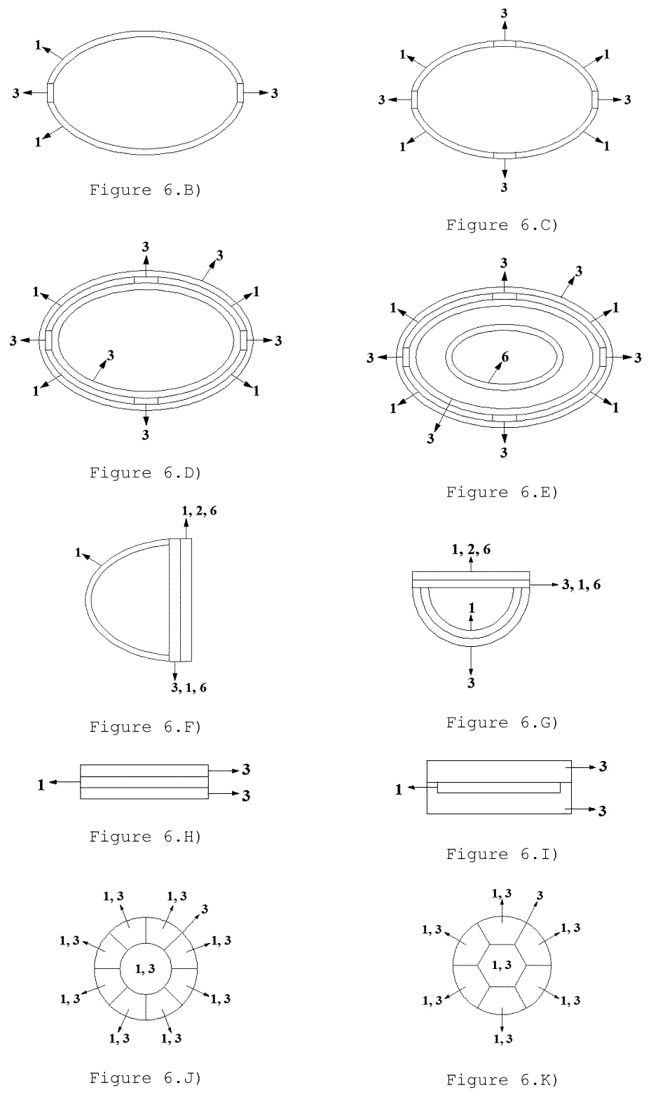

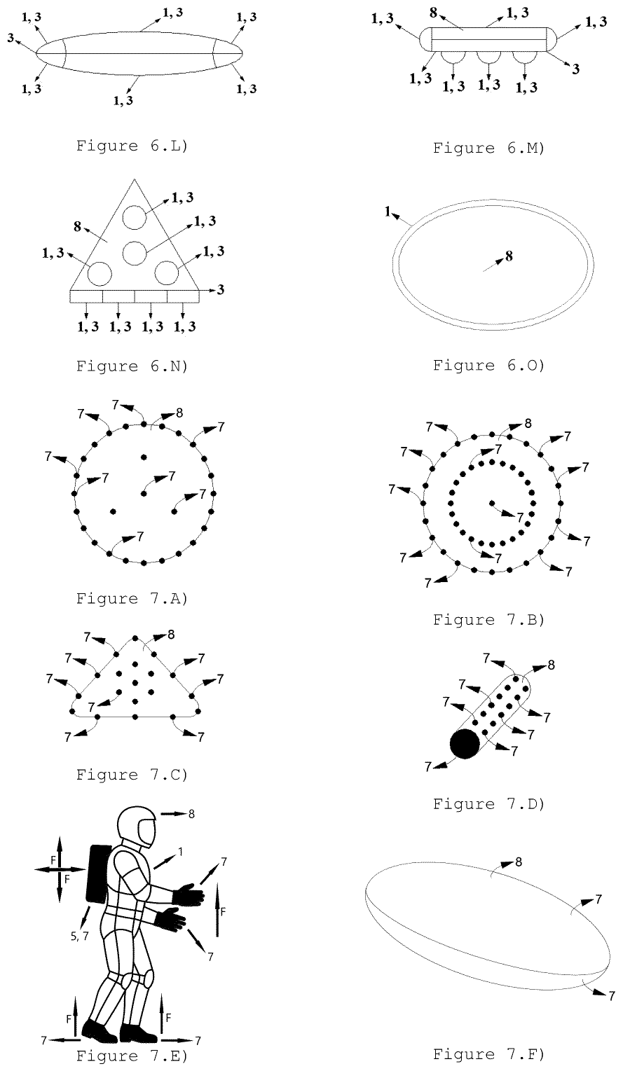

Note that by using one or more first conductors 1 on the exterior or surface of the ship (FIGS. 1.D through 1.M) driven by asymmetric V·∂V/∂t, or E·∂E/∂t, voltage or electric field waveforms, repulsion forces will be generated on any external mass that is in the line of motion of the ship as given by Equation (13), and also a propulsion force will be developed on the whole of object 8 (described in relation to FIGS. 1F to 1.M, FIGS. 5.A to 5.P and FIGS. 6.A to 6.O) without inertial forces because the volume of pulsed fields encompass the whole volume of object 8 as required and explained in detail from to [67]. This implies that the atmosphere will automatically be repelled, or if the ship is surrounded by water, then the water itself will also be repelled in the direction of the ship's motion, just as any object in the ship's line of motion will be repelled as it moves through space.

In this propulsion system, teleportation will be generated when V·∂V/∂t, or E·∂E/∂t, exceed a certain threshold value. The phenomenon happens because the electric field E is proportional to the space-time velocity through the relationship for the electric field linear momentum, which is equivalent to the space-time linear momentum, as given by Equation (10). Regardless of the direction of the space-time velocity with respect to the electric field vector E, we can observe that ∂E/∂t represents an acceleration of space-time, which behaves like a superfluid as explained in Einstein's theory of Relativity (Gron, O., and Hervik, S., “Einstein's General Theory of Relativity,” Springer Science, 2007). As is known in fluid dynamics, under the name supercavitation, when a fluid is accelerated, above a certain limit velocity, then a phase change will occur in the fluid from liquid to gas phase, for example, dramatically decreasing its density and consequently dramatically increasing the velocity of propagation allowed through it.

Thus, by applying a single asymmetric pulse of extremely high magnitude, V·∂V/∂t or E·∂E/∂t, above a given transition value, teleportation will be generated in the same direction as the “space warp”, or polarization, or displacement force, Equations (11) and/or (13) and/or (23), where the distance traveled in a single teleportation “jump” will depend on the total magnitude of the pulse used. For the generation of teleportation and the displacement of masses without inertia, the generation of asymmetrical V·∂V/∂t or E·∂E/∂t waveforms, distributed completely or partially within or around the mass 8 to be transported, is required.

Using Equation (2), Equation (14) can also be written as:

$${f}_{KE} = P \cdot ∇ E = E \cdot ∇ P = {ε}_{0} E \cdot ∇ [ ( {ε}_{r} - 1 ) E ] \qquad ( 24 )$$

Therefore, when we pulse electric fields, the force generated will be proportional to the spatial (or temporal) gradient of the electric fields, but also proportional to the gradient of the relative electric permittivity er of the dielectric 3 material used in the capacitor. Equation (24) also gives the force generated when the applied voltage and electric field are constant, oscillating, rectified oscillating or pulsed, with symmetrical or asymmetrical capacitors. If the capacitor is symmetric and the electric field constant, then the force generated will be given by:

$${f}_{KE} = {ε}_{0} E \cdot E ( ∇ {ε}_{r} - 1 ) \qquad ( 25 )$$

That is, the force will be proportional to the spatial gradient of the relative electrical permittivity Er of the dielectric 3 material used in the capacitor. This is another way to use capacitors for propulsion using the application of constant, oscillating, rectified oscillating or pulsed electric voltages and fields. Dielectric 3 may be of one or more materials, uniform or non-uniform individually, placed or used in such a way that they generate a gradient of the relative electrical permittivity εᵣ along dielectric 3 in a given direction.

Although our preferred application uses asymmetrically pulsed V·∂V/∂t or E·∂E/∂t waveforms with uniform dielectrics 3, the application of non-uniform dielectrics 3 may increase the force generated if the gradient of the relative electric permittivity εᵣ of the dielectric 3 material used generates a force in the same direction as the applied asymmetric pulses. Our specific configurations for constant or oscillating voltage application use only capacitors fully encapsulated by dielectric 3, since the use of constant or oscillating voltages for propulsion in asymmetric capacitors with a gradient of the relative electrical permittivity εᵣ of the dielectric was used in U.S. Pat. No. 3,187,206 (1965) cited above, where all the conductors of the capacitors used were exposed to the atmosphere and not fully encapsulated as here.

To finalize the theory that supports the present space drive system we will now show mathematical proof that the displacement, polarization or “space warp” force from Equations (11), or (13) or (23), due to the asymmetry of V·∂V/∂t or E·∂E/∂t waveforms, is non-conservative as necessary in order to be able to generate directional propulsion forces in capacitor systems due to the conservation of total momentum. There are several conditions that non-conservative vector force fields must satisfy that are mutually equivalent (Griffiths, D. J., Introduction to Electrodynamics 4th edition, Pearson Education Inc, 2013), so by proving one of them the rest generally follows. One of those is that the divergence of the force field must be zero: ∇·F=0 (Du, J., et al., “Tayloring Optical Gradient Force and Optical Scattering and Absorption Force,” Nature Scientific Reports 7, 18042, 2017), which is easily proven in our case:

$$∇ \cdot ( \frac{{ε}_{0}}{c} E \cdot \frac{\partial E}{\partial t} + \frac{E}{c} \cdot \frac{\partial P}{\partial t} ) = \frac{1}{c} ∇ \cdot ( {ε}_{0} \frac{\partial E}{\partial t} + \frac{\partial P}{\partial t} ) \cdot E = \frac{1}{c} ∇ \cdot ( \frac{∇ \times B}{{μ}_{0}} ) \cdot E = 0 \qquad ( 26 )$$

Where we have used the differential form of the Ampere-Maxwell's Law (Fleisch, D., A student's guide to Maxwell's equations, Cambridge University Press, 2008). ∇·∇×B will always be zero for any vector B (Fano, R. M., Adler, R. B., and Chu, L. J., Electromagnetic Fields, Energy, and Forces, John Wiley & Sons, 1963) showing that forces associated with asymmetrically

$$E \cdot \frac{\partial E}{\partial t} or V \cdot \frac{\partial V}{\partial t}$$

pulsed capacitors are divergenceless and non-conservative, that is, where the fields are just dissipating their energy and momentum in matter when performing work (generating directional propulsion forces) on them (Jackson, J. D., Classical Electrodynamics, Wiley New York, 1998).

The present invention will now be described in detail, without limitation and by way of example, by means of preferred embodiments, represented in the attached drawings, in which:

FIGS. 1.A to 1.M describes the theory of the “space warp” or displacement/polarization force that acts on capacitors, due to the total conservation of linear momentum.

FIGS. 2.A to 2.G represents various forms of electrical excitation to generate propulsion in capacitors.

FIGS. 3.A to 3.T represents various forms of experimental examples of application of propulsion systems using capacitors and the associated thrust generating waveforms.

FIGS. 4.A to 4.Y represents various forms of application of propulsion systems using capacitors.

FIGS. 5.A to 5.P represents various forms of application of propulsion systems, attenuation of inertia and generation of force fields, using capacitors where the same first conductor 1 is shared by several second conductors 2.

FIGS. 6.A to 6.O represents various forms of application of propulsion systems, attenuation of inertia and generation of force fields, using capacitors with a single first conductor 1 that can be segmented or whole.

FIGS. 7.A to 7.F represents various ways of applying the propulsion units to structures with different geometries.

### DESCRIPTION OF THE PREFERRED EMBODIMENT

With reference to the figures, the preferred embodiment of the invention will now be described. In the attached figures, equal numbers correspond to equivalent components in the different configurations.

Each of the configurations we will describe results from a natural development of the previous one, using the same physical principles to generate the propulsion forces described above, being natural and different variations that complete and complement each other.

Consider a capacitor formed by a first conductor 1 and a second conductor 2, both disc-shaped, connected to a power supply 5, which generates a static, unipolar oscillating rectified or pulsed asymmetric voltage, and separated by the dielectric 3. For this and all other configurations we consider first conductor 1 to be positive and second conductor 2 to be the opposite polarity, with either of these conductors having the possibility of reversing their original electrical polarity or also being the ground or zero reference.

Under these conditions (FIG. 2.A), and the assembly being in a vacuum, when a threshold voltage is exceeded between first conductor 1 and second conductor 2, a discharge will be generated through dielectric 3, by volume if it is a gas or through its surface if it is a solid. In the first case we have “spark gap” discharges in vacuum or with gas at low or high pressure and in the second case we have a “surface discharge” along the surface of the used solid or liquid dielectric. This discharge will cause a conduction current I (FIGS. 2.A to 2.F) to run through the dielectric 3 which behaves under these conditions as a switch 4 with an RLC (resistive/inductive/capacitive) load, sometimes approximated as a resistive load, which dissipates the energy of the capacitor causing the voltage in first conductor 1 and second conductor 2 to drop sharply. This sudden voltage variation will generate a force on the capacitor according to Equation (13). This assembly (the capacitor or propulsion unit 7 and switch 4) or only switch 4 may also be inserted inside a shield 6, which can be made of a dielectric or conductive or magnetic material, for the purpose of protection or to maintain inside a vacuum or gases suitable for its operation (FIG. 2.B). We note herein forward that we consider a propulsion unit 7 a capacitor with one or more first conductor 1 and second conductor 2, or a capacitor with only one or more first conductor 1, with a dielectric 3 in-between said one or more first conductor 1 and second conductor 2, or with a dielectric 3 on the surface of said one or more first conductor 1. In order to work, this propulsion unit 7 has to be connected to a power supply 5, that generates the necessary waveforms to generate propulsion, where we consider that the energy source (battery or generator) necessary for operation is already part of power supply 5. Power supply 5, as a skilled person in the art will appreciate, can be a portable battery, or a suitable wireless energy storage unit. The application of the pulses can be programmed externally to the power supply 5 via suitable and known programmable means, for example, a control unit (not shown) in order to control the application of the pulses in intensity, in shape, in duration, and/or in intervals between pulses, such that the desired effect of propulsion is obtained on the object 8. The control unit can be attached to the propulsion unit 7 of the invention, to the power supply 5 or the control unit can communicate with the power supply 5 in a wireless way (not shown).

In the preferred embodiment with the capacitor formed by first conductor 1 and second conductor 2 completely wrapped inside a dielectric 3, there is also the possibility of the occurrence of a surface discharge along dielectric 3, thus generating propulsion forces as well (FIG. 2.C), although this condition is not encouraged due to the erosion of dielectric 3 with time. By using a greater thickness of the dielectric 3, we can avoid this type of discharges.

Propulsion forces may also be generated if an electrically charged capacitor, has one of its conductors abruptly charged or discharged via a power supply 5 in combination or not with a switch 4 (FIG. 2.D), which can be resistive and/or inductive and/or capacitive (RLC) or any combination therewith. To generate propulsion forces, one or both first conductor 1 and/or second conductor 2 may be abruptly charged or discharged by power supplies 5 through the optional use of appropriate switches 4 (FIG. 2.E). The switch 4 may be made up of normal resistors/inductors/capacitors or any combination thereof with or without any other type of switch, like for example “spark gap” type switches (vacuum or high pressure gases) including “vacuum surface discharge” switches in dielectrics, or solid state electronic switches or mercury switches or any other type of available switch. The switches 4 used should preferably have the fastest charge or discharge time at the highest possible voltage and repetition rate, in order to generate greater forces, or they could be designed in order to obtain the discharge times and with a pulse repetition rate suitable for each application.

Another option will be to charge said capacitor through a power supply 5 (FIG. 2.F), which delivers static voltage, and use a switch 4 to abruptly charge or discharge the capacitor with symmetrical or asymmetrical times, generating propulsive forces (FIG. 2.F, FIG. 1.B and FIG. 1.C). Our preferred configuration, however, will be to use a capacitor completely encapsulated in a dielectric 3, using only a power supply 5 (FIG. 2.G) that directly debits appropriate voltage pulses with asymmetrical E·∂E/∂t derivative to the capacitor, directly generating propulsion forces (FIG. 2.G, FIG. 1.B and FIG. 1.C). In all the preceding cases and the following ones, when using at least a first conductor 1 and a second conductor 2, the generated force vectors will be in two possible opposite directions collinear or aligned with the capacitor axis, that is, the direction from first conductor 1 to facing second conductor 2 (FIGS. 1.B and 1.C). When using at least one first conductor 1 (with “virtual” second conductor 2), the generated force vectors will also be in two possible opposite directions, perpendicular to the surface of first conductor 1 (FIGS. 1.F to 1.M).

Our preferred configuration using a capacitor completely encapsulated in a dielectric 3 will be able to use disk-shaped first conductor 1 and second conductor 2 (FIG. 4.A) and generate propulsion forces in both directions perpendicular to the face of the conductors depending on the shape of the applied pulse as described earlier. As way of non-limiting examples of voltage waveforms to use we suggest using 1) unipolar (positive or negative) symmetric pulses with symmetric rise and fall times like rectified sinusoidal, or rectified square or rectified triangle or rectified symmetric ramp signals, or any other symmetric rectified pulse, or 2) unipolar (positive or negative) asymmetric pulses with asymmetric rise and fall times like asymmetric ramps or asymmetric triangles, or asymmetric squares or asymmetric sinusoidal signals, or any other asymmetric rectified pulse, as described earlier in relation to FIGS. 1.B and 1.C and FIGS. 3.J to 3.T. In simple terms, the force direction will be determined depending on the polarity applied and the symmetry or asymmetry of rising and falling times of V·∂V/∂t or E·∂E/∂t, which determine the direction of stronger electric field momentum change and therefore the direction of the generated force (FIGS. 1.B and 1.C). If the power supply 5 debits a pulse shape that generates forces only in one direction, that is, in the case the rise and fall time of the pulses are fixed and cannot be changed on demand, in order to reverse force direction we can just swap the electrical connections of first conductor 1 and second conductor 2 to power supply 5 or we can use a further second conductor 2 in order to control the direction of the force produced by electrically feeding second conductor 2 used to the right or left of first conductor 1, to generate forces in opposite directions (FIG. 4.B). We can use any number of first conductors 1 and second conductors 2 in succession in the same capacitor, where all can be connected to power supplies 5 (not shown), with respective energy sources (not shown), or only the external conductors can be connected to power supplies 5 (FIG. 4.D), or external conductors can be first conductors 1 (FIG. 4.C) or second conductors 2, or any mixture of the same, and where first conductors 1 and second conductors 2 can assume any electrical polarity (FIG. 4.D), wherein the electrical polarity of first conductors 1 is the opposite of that of second conductors 2. When only external conductors are connected to a power supply 5 (FIG. 4.D), then the connected electrodes will induce an opposite polarity in nearby conductors by the process of electrical induction so the polarity of nearby conductors would still remain in opposition.

The force of Equation (13) works for any type of capacitor that has electric field vectors that do not cancel each other, and has asymmetric E·∂E/∂t derivatives when varying them. In this way, the possible variations of geometry used for first conductors 1 and second conductors 2 are unlimited and may include any geometry or cross-section other than those specifically mentioned. As a non-limiting example, first conductors 1 and second conductors 2 may include circular, cylindrical, oval, ellipsoidal, convex, concave, square, rectangular, triangular, hexagonal and so on, solid or hollow geometries with a hole in the middle, and any mixture thereof. The geometries used in first conductors 1 and second conductors 2 may be equal to each other and with equal or different relative size, and these may also not be equal to each other in their geometry or size.

Some non-limiting examples of these variations are given in FIGS. 4.E through 4.X, where first conductors 1 and second conductors 2 in ring or toroid form may be used (FIG. 4.E), with the surrounding dielectric 3 accompanying the central opening or not. Another variation is the use of several curved first conductors 1 and second conductors 2 in succession (FIG. 4.F) or a curved first conductor 1 with a flat second conductor 2, or a curved first conductor 1 and a spherical or discoidal second conductor 2 (FIG. 4.G). Or a ring-shaped second conductor 2 facing a curved first conductor 1, which could be a curved surface or a wire (FIG. 4.H). Other variations include using cylindrical conductors (FIG. 4.1), or horizontal planes (FIG. 4.J) that are linear or close in on themselves (FIG. 4.K), where first conductors 1 and second conductors 2 do not need to be equal to each other. We can also use asymmetrical flat or curved first conductors 1 and second conductors 2, that is, with a relative size different from each other, where dielectric 3 does not follow (FIG. 4.L) or follows the asymmetry of first conductors 1 and second conductors 2 (FIG. 4.M).

Another variation that allows the capacitance of a capacitor completely surrounded by dielectric 3 to be increased will be by connecting several first conductors 1 parallel and independent of each other in series, increasing the total capacitance of the several first conductors 1, using one or more of first conductors 1 in series. By making the same type of series connection for several second conductors 2 parallel and in series, in equal number used for first conductors 1 we will have a symmetrical capacitor of multiplied total capacitance (FIG. 4.N) that will generate a greater force for the same applied pulse. If the number of series conductors used for the total of first conductors 1 and second conductors 2 is different for first conductors 1 or second conductors 2 (FIG. 4.O) we will have an asymmetric capacitance capacitor that will generate a larger force depending on the direction of the capacitance gradient. In this case we can apply direct or oscillating voltages, and if we apply asymmetric electrical pulses, these should be chosen so that they generate a force in the same direction caused by the capacitance gradient. In addition to flat shapes (FIGS. 4.N and 4.O) we can use first conductors 1 and second conductors 2 with a convex shape (FIGS. 4.P and 4.Q) or any other shape.

Despite all these possible variations, our preferred configuration uses only disk-shaped first conductors 1 and second conductors 2, as in FIGS. 4.A through 4.D, or rectangular and long, with possible horizontally aligned cross-section (FIG. 4.R) or with variations on that horizontal alignment (FIG. 4.S).

Another geometry preferred by us includes first conductors 1 and second conductors 2 with a triangular shape, simple or similar to that of pizza slices, distributed horizontally in a lateral circular fashion along 360° (FIG. 4.T), where the lateral first conductors 1 and second conductors 2 may be driven in an isolated and independent manner or all may be driven simultaneously and interconnected, and these may be subjected to opposite or equal polarities in the same horizontal plane, the application of equal polarities being preferable (FIG. 4.T). In this case, the pizza configuration of conductors (FIG. 4.T) could be a top view of an assembly with cross section aligned or not horizontally (FIGS. 4.R and 4.S), and where first conductors 1 and second conductors 2 can maintain or change their size and dimensions along their cross section, and the assembly can have a 3D cylindrical (FIGS. 4.R and 4.S), or angular or conical (FIGS. 4.U and 4.V) shape. The configuration in FIG. 4.T has the advantage of controlling the direction of the force generated by the choice of first conductors 1 and second conductors 2 excited by power supply 5 (not shown), allowing to easily change the direction of the resulting force vector.

Preferably when the voltage used on first conductors 1 and second conductors 2 is lower than the ionization voltage of the surrounding gas we can partially expose first conductors 1 and second conductors 2 to that gas (or atmosphere or environment) (FIGS. 4.W and 4.X). In addition to symmetrical capacitors exposed to the atmosphere (FIG. 4.W) we may also use asymmetrical capacitors, where an additional possible variation includes part of first conductor 1 being extended or partially extended in a small tab or extension (or more than one extension) to the opposite surface where second conductor 2 is (FIG. 4.X), and/or reciprocally second conductor 2 optionally having one or more tabs or extensions to the surface where first conductor 1 is located. This is a widely used conductor configuration in piezoelectric capacitors that allows connecting wires to be used with first conductors 1 and second conductors 2 on the same surface, and can be used in our case, with first conductors 1 and second conductors 2 partially or completely surrounded by dielectric 3.

All the configurations shown in FIGS. 1.A to 1.M, 2.A to 2.G and 4.A to 4.X represent propulsion units 7, which can be optionally wrapped and shielded by shield 6 made of dielectric or conductive or magnetic materials for the purpose of containing in space the electromagnetic fields generated by propulsion units 7 in such a way as to prevent electromagnetic emission that could impair the operation of nearby electrical equipment (FIG. 4.Y), as well as to prevent exposure to these fields of people or biological material or equipment (or any other material) near the propulsion units 7. Another possible function of using a shield 6, acting as an envelope, will also be in increasing the capacitance of the propulsion unit 7 used. Note that first conductors 1 and second conductors 2 can have any thickness, although as a way of non-limiting example, we would advise thicknesses from 0.1 mm to 10 mm (we have used 3 mm thicknesses in our setups), where they can also be thin as paint or thin film, and made of any conductive, superconducting or semiconducting material, with the possibility or option of painting their surface with paint of small conductive, semiconducting or magnetic particles, or nano particles of carbon, graphene or any other material, with positive or negative permittivity or permeability, in order to increase their total capacitance or improve their properties.

So far we have used common capacitors with one first conductor 1 to a second conductor 2, where several conductors were used aligned in parallel in order to increase the capacitance and flexibility of the propulsion system. Let us now consider another variation of simpler and more efficient application. In this case we will use capacitors with a single first conductor 1 to two or more second conductors 2, separated by dielectric 3 (FIG. 5). In this case, both first conductors 1 and second conductors 2 may be exposed to the outside environment without dielectric protection (FIG. 5.A), or only the second conductor 2 may be completely enveloped by dielectric 3 (FIG. 5.B), or both first conductors 1 and second conductors 2 may be partially or completely enveloped by dielectric(s) 3 (FIG. 5.C).

We may use any number of second conductors 2 in conjunction with a first conductor 1, distributed randomly or in any pattern and geometry, such as by non-limiting example using distribution patterns of second conductors 2 triangular, quadrangular, pentagonal, hexagonal, circular, rectangular, ellipsoidal, and others, with or without one or more second conductors 2 placed at the center of that distribution. For example, we might use three second conductors 2 together with a first conductor 1, separated by dielectric 3, where first conductors 1 and second conductors 2 might be completely enveloped by dielectric 3 (FIG. 5.C) or where only second conductor 2 or first conductor 1 might be exposed to the environment (FIG. 5.D). A front view of the cross section of FIG. 5.D) might use second conductors 2 in a triangular distribution pattern with another second conductor 2 in the center, or where second conductors 2 might be in a quadrangular pattern with another second conductor 2 in the center (FIG. 5.E).

Both first conductors 1 and second conductors 2 may have any geometric shape, two-dimensional or three-dimensional. So far we have considered flat first conductors 1 (FIGS. 5.A through 5.E), but these may also have two-dimensional flat ring round shapes or three-dimensional hollow spherical shapes or spheres (FIG. 5.F). In this case we can have any number of second conductors 2 distributed in any arrangement inside first conductor 1 and separated from it by dielectric 3. For example, by using eight second conductors 2 inside first conductor 1 (FIG. 5.F), we can generate propulsion forces in any of the eight available directions in a controlled manner. The dielectric 3 may wrap only a limited area around second conductor 2 (FIG. 5.F) and/or the dielectric 3 may be distributed in a uniform (or non-uniform) layer completely inside first conductor 1 (FIG. 5.G). In order to protect people, equipment or any other material, we can use a shield 6 inside first conductor 1 (FIG. 5.H), accompanying or not or dielectric 3 that surrounds each second conductor 2. This shield 6 may also cover externally, in isolation or individually, each second conductor 2 and respective dielectric 3.

As we mentioned, several other shapes for first conductor 1 could be used, such as circular, round, spherical, tubular, square, triangular, pentagonal, hexagonal, or oval shapes made from a single first conductor 1 (FIG. 5.1). This shape may be made of a single first conductor 1 (FIG. 5.1), or the same shape may be made with several independent sections of several first conductors 1, in electrical contact with each other or separated by dielectric 3, or separated by any other material. For example, we could segment the same oval shape into two independent sections, an upper and a lower one, separated by dielectric 3 (FIG. 5.J). Or we can segment the same first conductor 1 into two independent sections, one on the right and one on the left (FIG. 5.K), separated by the dielectric 3. Or we can segment first conductor 1 into four different sections, above, below, right and left in a mixture of the two previous cases; where first conductor 1 could be segmented into any number of independent sections.

Another alternative shape for first conductor 1 could be a curved section corresponding to half a sphere or oval (FIG. 5.L). In this case the flat part on the right may consist of first conductor 1, or shield 6, or dielectric 3, independently or simultaneously; where dielectric 3 may optionally separate curved first conductor 1 from another flat first conductor 1, or flat second conductor 2, or a shield 6 having a flat shape. We have mentioned only a few forms of all the variety that will be possible.

So far we have used second conductors 2 on the inside of curved first conductors 1 (FIGS. 5.F through 5.L) but second conductors 2 may also be used similarly on the outside of curved first conductor 1, separated from each other as before by dielectric 3 individually (FIG. 5.M). Each of the second conductors 2 and external dielectrics 3 can be optionally protected by the shield 6 individually (FIG. 5.N) or globally (FIG. 5.O), where we can use the dielectric 3 individually on second conductors 2 (FIG. 5.O), or dielectric 3 (or several dielectrics 3), may be used globally involving all second conductors 2 between first conductor 1 and shield 6 (FIG. 5.P), and where first conductor 1 and shield 6 may be used reciprocally within or outside of each other (FIGS. 5.0 and 5.P). The relative position of second conductor 2 between first conductor 1 and shield 6 (which could also be another conductor) can be calibrated for the purpose of more efficient propulsion generation. The external and/or internal side of first conductor 1 (or shield 6 if it is a conductor) may optionally be covered by any type of dielectric 3 in order to increase its capacitance.

If we excite the external first conductor 1 of the propulsion configurations shown in FIG. 5 with asymmetric V·∂V/∂t or E·∂E/∂t waveforms, we will generate additional propulsion forces in addition to the forces generated by interaction with second conductor 2. These additional propulsion forces are given in general form by Equation (23) and have been discussed in the configurations shown in FIGS. 1.D through 1.M, by applying asymmetric voltage or electric field pulses to whole or segmented curved first conductors 1 of any shape or geometry. In this case, the forces generated are independent of the use of a first conductor 1 in conjunction with a “physical” second conductor 2, due to the capacitive interaction that the external first conductor 1 has with its external environment which in this case is the second conductor 2 because it behaves like a “virtual” second conductor 2. In this way we can also generate propulsion forces if we electrically excite or use only the outer first conductor 1 and subject it to asymmetric V·∂V/∂t or E·∂E/∂t waveforms.

In this way we can use two or more external first conductors 1 in any number of independent conductive sections of first conductor 1, separated by dielectric 3, or separated by any other material. For example, we might segment the same oval shape into two independent sections, one on the right and one on the left, separated by dielectric 3 (FIG. 6.A). Or we can segment the same first conductor 1 into two independent sections, one upper and one lower (FIG. 6.B), separated by dielectric 3. Or we can segment first conductor 1 into four different sections, above, below, right and left in a mixture of the two previous cases (FIG. 6.C). In order to increase the capacitance of the outer first conductors 1 these can be optionally externally coated by dielectric 3 (FIG. 6.D). The same external first conductors 1 may also optionally be internally lined by dielectric 3 (FIG. 6.D). The various segmented first conductors 1 used to generate an overall spherical, oval or any other shape already naturally negate the presence of any electric field inside, however, an optional shield 6 internal to the segmented first conductors 1, and internal dielectric 3, may be used to additionally shield any material from any electric field or electromagnetic radiation that may exist (FIG. 6.E).

Another alternative shape for first conductor 1 could be a curved section corresponding to half a sphere or oval (FIG. 6.F). In this case the flat part on the right may consist of first conductor 1, or shield 6, or dielectric 3, independently or simultaneously; where dielectric 3 may optionally separate curved first conductor 1 from flat first conductor 1, or flat second conductor 2, or a flat shaped shield 6. We mention only a few forms of the whole variety that will be possible, where the curved first conductor 1 (or the flat first conductor 1 or second conductor 2) may be coated internally and/or externally by dielectric 3 as described earlier (FIG. 6.G).

Flat first conductors 1 can generate propulsion forces if they have dielectrics 3 on opposite faces with different values of relative electrical permittivity, where the different dielectrics 3 can partially (FIG. 6.H) or completely (FIG. 6.1) surround first conductor 1.

Several non-limiting examples of how several first conductors 1 separated by the dielectric 3, may be arranged into several different geometries will be given below. Since first conductors 1 are preferably and optionally externally wrapped by dielectric 3, we use the designation of both simultaneously. Simple lines separating these elements represent dielectric 3. The simplest shape will be the spherical shape segmented into any number of sections (FIG. 6.J). This spherical shape may use curved, round or spherical first conductors 1 (FIG. 6.J) or the same spherical shape may consist of first conductors 1 with hexagonal sections that fit perfectly together (FIG. 6.K). Alternatively, oval (FIG. 6.L) or cigar (FIG. 6.M) shapes could be used to move a mass or object 8, where several smaller first conductors 1 could be used additionally creating macroscopic and microscopic composite shapes (FIG. 6.M). Another option could be the use of global triangular shapes with several additional smaller first conductors 1 used to vectorially control the generated force (FIG. 6.N). We have mentioned only a few of the many possible options.

Dielectric 3 can consist of any solid, liquid or gaseous material, and can have a positive or negative, linear or non-linear relative permittivity, which will influence the direction and magnitude of the force generated, or even be vacuum itself or a gas at low or high pressure. This dielectric 3 may be pure or be a symmetric or asymmetric mixture of several different dielectrics, and may contain optionally embedded within it, symmetrically or asymmetrically, any number of small conductive, or semiconducting, or non-conductive, or magnetic, or nano particles of positive or negative, linear or non-linear permittivity or permeability, such as metallic, or magnetic, or semiconducting, or other powder or paint. Dielectric 3 may include the use of piezoelectric, or pyroelectric, or ferroelectric, or metamaterials, or glass, or quartz, or ceramics, or plastics, or any other type of dielectric. Where dielectric 3, and/or shield 6, and/or first conductors 1 or second conductors 2 may be metal matrix composite materials, and/or ceramic matrix composite materials, and/or carbon matrix composite materials, and/or polymer matrix composite materials, among many other possibilities.

The propulsion units 7 can be independent or on the contrary be connected together in any distribution or grid. In all propulsion units 7 we can use ultra-capacitor properties and specifications or use materials that generate superconductivity or cooling systems for superconducting operation. We can also use in all propulsion units 7 any power supply 5 of high or low voltage or current, constant high voltage power source with switches 4 or with resistors 4 having switches 4, oscillating power source coupled to a constant power source, rectified oscillating symmetric waveforms (unipolar sinusoidal waves, or square unipolar, or triangular unipolar among other possibilities), or rectified asymmetric waveforms (unipolar asymmetric ramps or other), pulsed or any other, including any waveforms with asymmetrical E·∂E/∂t or pulses with asymmetrical V·∂V/∂t, in conjunction or not with switches 4 or with resistors 4 having switches 4. Examples of non-limiting power supplies 5 include Marx generators, inductive voltage pulse generators, Tesla coils, unipolar waveform wave pulse generators, high voltage microwave generators with symmetric or asymmetric voltage pulses or rectified unipolar waveforms, bipolar high voltage (HV) power supply DC with switch 4 or with resistors 4 having switches 4, or bipolar HV rectified or bipolar HV AC with DC unipolar, any high voltage DC power supply with switch 4 or with resistors 4 having switches 4 among many other options. Please note that unipolar refers to the use of a positive polarity or negative polarity in rectified signals. Bipolar refers to a power supply that outputs both polarities at the same time.

A protective force field may be generated by the propulsion units 7 or by a single whole first conductor 1 (FIG. 6.O) or segmented, with arbitrary shape (FIGS. 5.A to 5.P and 6.A to 6.O) placed around an arbitrary object 8, moving or stationary, where in the latter case the total resulting force on the object 8 will be symmetric and zero, due to the symmetric application of the force fields, but any external object approaching the object 8 will be strongly repelled, with total force given by Equation (13) where Vₒₗ will be in this case the volume of the external object being repelled. The repelling (and also attractive) effect is the same as the propulsive effect which acts on any dielectric material inside a two electrode capacitor (FIGS. 1.B and 1.C) generating a force in any of two opposite directions according to the applied pulses. When using only one or more external first conductors 1 the applied pulses will generate pulsed fields on the outside of object 8, that will affect any nearby external dielectric or magnetic object with attracting or repelling forces depending on the waveform used as explained earlier in relation to FIGS. 1F to 1.M. That is, the force arrows on FIGS. 1F to 1.M are not only valid for the propulsion forces generated on object 8 but also on any nearby external object with repelling or attractive forces. If the pulsed fields around object 8 are symmetric in volume then it will not move but will be protected by the force field if it is repulsive (FIGS. 1.F and 1.I). Any small asymmetry in the force fields will allow the movement of the object 8 in a given direction with full protection by the generated force fields. Possible applications of these (repulsive or attractive) force fields are numerous and include the reduction of atmospheric or water friction for cars, airplanes, boats, or submarines, allowing water vehicles to move to any depth, as well as moving spacecraft in space, in the atmosphere, or on water, completely protected and free from collisions with masses. As an example of application of the generated force fields, we have the repulsion, attraction or deflection of space debris or hazardous asteroids to planet Earth, or direct transport of asteroids using the repulsion or attraction forces generated by the force fields. Another application will be to extinguish forest fires or any kind of fires simply by using the repulsion forces generated by force fields by the approach of an airship or object 8 using a propulsion system like the one reported in this patent application, which generates force fields at a distance and with a large volume.

Other potential applications include attenuation of inertia of object 8, as explained in detail from [59] to [68], teleportation of object 8, as explained in detail from [69] to [70], and protection from mechanical impacts in any mass or object 8, if using a repelling force field around object 8 as explained in [112], such as vehicles (cars, airplanes, among others, or the system of FIG. 5.I, dwellings, habitations, doors, windows, or people dressed, covered or surrounded completely or partially by the first conductor 1 (FIG. 6.O), which, may be rigid or flexible, uniform or segmented, and thick or thin (paint for example), and be optionally coated on the outside and/or inside by one or more dielectrics 3 (FIG. 6.D), where first conductor 1 may optionally be internally coated also by shield 6 (FIG. 6.E) or by any other material.

In addition to general use in flying vehicles carrying people or equipment, another possible civil or military application will be the generation of propulsion, and/or attenuation of inertia, and/or protection from mechanical impacts, in people fully or partially dressed in individualized suits of rigid or flexible material of first conductor 1 with a shape adapted to the human body, i.e., which follow the shape of the body, or with any other shape, using any of the propulsion units 7 or using uniform, i.e., one-piece, or segmented, i.e., several first conductors 1 in close proximity to each other and electrically connected to each other or separated by dielectric 3 or any other material (FIG. 7.E). In this case, as way of non-limiting example, the propulsion unit 7 together with power supply 5 could be placed in a backpack to be worn by a person and the propulsion unit 7 can generate forces in any desirable direction (FIG. 7.E), in different instants in time, according to a control program that a control unit mentioned hereinbefore in this application may run and apply to the propulsion system of the invention. In the application shown in FIG. 7.E, the control unit (not shown) could be commanded by the user of the suit via a suitable user interface (not shown) connected to the user or for example in the backpack. As a possible extension or option, additional propulsion units 7 could be placed on the feet or hands and powered by the power supply 5 on the back (FIG. 7.E). This can be achieved by placing propulsion units 7 inside a shoe or attached to a shoe, or to both shoes, as well as to a skate or flying board, where the power supply 5 and the propulsion units 7 can also be placed, for example. Similarly, the propulsion units 7 can be provided inside a glove or two gloves, to be worn by a person. When the propulsion units 7 installed in a shoe or in a glove of a person, the power supply 5 applying the pulses thereon can be provided inside the shoe or glove or preferably can be provided also inside the backpack. In embodiments wherein the power supply 5 is provided in the backpack, the connection between the power supply 5 and the first conductors 1 and the second conductors 2 in the shoe or in the glove can be wired through the metallic armor or through the suit. Alternatively, the connection between the power supply 5 and the first conductors 1 and the second conductors 2 provided in a shoe or in a glove can be wireless. By applying asymmetric E·∂E/∂t pulses to first conductor 1, or several first conductors 1, we can obtain a conductive human armor or garment with remarkable properties including propulsion, and/or inertia attenuation, and/or protective shielding. Even the possible visor on the head, or the visor of any vehicle for external observation, could be made of transparent conductive material and be subjected to the same asymmetric pulses. Propulsion may be selectively applied to specific parts of this metallic suit or conductive armor, such as on the palms of the hands and soles of the feet, or on the chest and back, among other places. The result would be similar to the flying armor depicted in the fictional movie “Iron Man” (FIG. 7.E), but better given that the occupant of this armor could move very quickly and without inertia, with an electromagnetic rather than mechanical protective shield (or both together).

In order to illustrate some preferred and non-limiting applications of the previously discussed propulsion units 7 we now illustrate some concepts in FIG. 7. We can use a uniform distribution of propulsion units 7 around the periphery of the object 8, in order to control the horizontal or vertical direction of the propulsion forces (FIGS. 7.A to 7.F). In these cases we also use several propulsion units 7 distributed in triangular (FIG. 7.A), or hexagonal (FIGS. 7.C) and 7.D)), or circular (FIGS. 7.B) patterns along the top, bottom or side surfaces. Any uniform or non-uniform (random) pattern in the distribution of the propulsion units 7 may be used. Instead of using a few propulsion units at specific points on the mass or object 8, for example, a ship (FIGS. 7.A to 7.D and 7.F), an armor or suit (FIG. 7E), that we want to move, we could make the entire ship or object 8 a single propulsion unit (FIG. 7.F), using any of the propulsion units 7 shown in FIGS. 1.A to 1.M, 2.A to 2.G, 4.A to 4.Y, 5.A to 5.P and 6.A to 6.O, and the occupants can be protected from electromagnetic fields if they are inside a shield 6 acting as a Faraday cage or as a metallic, and/or magnetic and/or dielectric envelope, or if the propulsion units 7 themselves are enveloped by the shield 6 as discussed earlier. In case first conductors 1 or second conductors 2 are on the outside of the object 8, covered or not by dielectric 3, they will attenuate inertia and generate forces of repulsion or attraction on any external mass around them, including protective force fields and handling applications of nearby external objects.

As illustrated, any desired shape for the personal metallic suit, or ship, or object 8 may be used (FIGS. 7.A to 7.F). The only important factor is the use of one or more propulsion units 7 in order to control the direction of propulsion, which can be at the periphery of the object 8 or immersed in any position within it. Other variations to consider will be independent vertical, diagonal or horizontal parts of the object 8, for example, a ship, a suit that may contain propulsion units 7 and be movable and tiltable in any direction. All the variations discussed can be applied to motorcycles, cars, flying skateboards, submarines, airplanes, spaceships, drones, flying platforms in any environment, hang gliders, jetpack-type, back-mounted personal transportation systems (with or without a paraglider), or flying armor, with inertial dampening and protective shields similar to the fictional movie “Iron Man”, or flying motorcycles and cars, among many other related and unmentioned application possibilities.

The invention claimed is:

1. An electromagnetic propulsion system, comprising at least one propulsion unit (7), wherein said propulsion unit (7) comprises:
at least one capacitor formed by:
at least one first conductor (1) and at least one second conductor (2), wherein the at least one first conductor (1) and the at least one second conductor (2) are separated from each other and are partially or completely surrounded by a dielectric (3) material, and
one or more power sources (5);
wherein the at least one first conductor (1) and the at least one second conductor (2) are provided in succession on said capacitor, and said first conductor (1) and second conductor (2) are able to be subjected to voltage pulses V or electric fields E with asymmetric derivative of the product V·∂V/∂t or E·∂E/∂t, between said first conductor (1) and said second conductor (2), charged at opposite polarities or from one polarity to ground, wherein symmetric or asymmetric unipolar, positive or negative, voltage pulses V or electric fields E waveforms are applied by said one or more power sources (5) to one or more of the at least one capacitor, or to one or more of the at least one propulsion unit (7).

2. The electromagnetic propulsion system, according to claim 1, wherein one or more second conductor (2) are able to control the direction of a force produced by electrically feeding said one or more second conductors (2) used to the right or left of a first conductor (1), where the first conductors (1) and the second conductors (2) assume opposite electrical polarities, or from one polarity to ground.

3. The electromagnetic propulsion system, according to claim 1, wherein said at least one first conductors (1) and at least one second conductors (2) may have a geometry selected from the group consisting of a continuous closed contour of curvilinear or polygonal shape in two dimensions or three dimensions or the use of partial or half sections thereof, wherein the said at least one first conductors (1) and at least one second conductors (2) geometry is solid or hollow with a hole in the middle, such as toroids, cylinders or rings; wherein the said at least one first conductors (1) and at least one second conductors (2) have the same geometry or have different geometries, wherein said at least one first conductors (1) and at least one second conductors (2) have the same size or different relative sizes; and wherein optionally two or more first conductors (1) are connected in series, and/or two or more second conductors (2) are connected in series, in order to increase their respective total capacitance in a symmetric or asymmetric way in relation to the opposite conductor.

4. The electromagnetic propulsion system, according to claim 1, wherein said at least one first conductor (1) and at least one second conductor (2) are placed in a distribution or grid selected from the group consisting of linear distribution in the vertical, linear distribution in the horizontal, circular distribution in a 360° circle, horizontally distributed in a plane, vertically or angularly distributed in a plane, cylindrically distributed, conically distributed, distributed in a hemisphere, or any other 3D distribution shapes.

5. The electromagnetic propulsion system, according to claim 1, wherein the at least one first conductor (1) comprises a portion which extends in at least one tab or extension, to the opposite surface of the dielectric material (3) where the at least one second conductor (2) is, and/or the at least one second conductor (2) comprises a portion which extends in at least one tab or extension towards the surface where the at least one first conductor (1) is.

6. The electromagnetic propulsion system, according to claim 3, characterized by the use of capacitors or propulsion units (7) with a single first conductor (1) for two or more second conductors (2), separated by the dielectric (3), where each first conductor (1) and each second conductor (2) may be individually covered or not by a dielectric (3), completely or partially; where the first conductor (1) can have a flat bidimensional shape or a completely self closed or partially closed curved or polygonal tridimensional shape, separated by the dielectric (3), from two or more second conductors (2), that are placed on the inside or the outside of the first conductor (1); where the second conductors (2) can have a distribution relative to first conductor (1), as way of an example in a non-limiting way, selected from the group consisting of a continuous closed contour of curvilinear or polygonal shapes in two dimensions or three dimensions; where each of the second conductors (2) and dielectrics (3) internal and/or external to the first conductor (1) can be protected by a shield (6) individually or globally; where the first conductor (1) and the shield (6) can be used reciprocally inside or outside each other; where the relative position of the second conductor (2) between the first conductor (1) and the shield (6) can be adjusted; where the external and/or internal side of the first conductor (1), or of the shield (6) if it is a conductor, may optionally be covered by any type of dielectric (3); where if the first conductor (1) is a curved section corresponding to half of an oval or sphere or circle, the optional flat part on the right may be constituted by the first conductor (1), or by the shield (6), or by the dielectric (3), independently or simultaneously.

7. The electromagnetic propulsion system, according to claim 6, characterized by further comprising an object (8), wherein two or more first conductors (1) are provided externally at or close to the surface of the object (8), where the second conductor (2) is constituted by the external environment itself; wherein the two or more first conductors (1) are separated laterally by the dielectric material (3), or separated by any other material; where first conductors (1) can be coated externally and/or internally optionally by dielectric (3); where a shield (6) internal to the segmented first conductors (1) can be optionally used; and wherein the dielectric material (3) has equal or different relative electrical permittivity on opposite faces.

8. The electromagnetic propulsion system according to claim 1, further comprising the use of one or more switches (4) of a type selected from the group consisting of resistive and/or inductive and/or capacitive switches, or any combination thereof, including by way of non-limiting examples, the “spark gap” type, the “vacuum surface discharge” type, the hydrogen high pressure type, resistor type, inductive type, capacitor type, solid state type, mercury type in conjunction with the one or more power supplies (5), able to allow charging or discharging of the at least one first conductor (1) and/or the at least one second conductor (2), and wherein said switches (4) are provided internal and/or external to the capacitor or propulsion unit (7) itself.

9. The electromagnetic propulsion system, according to claim 1, wherein the at least one capacitor or propulsion unit (7) is a symmetrical capacitor or asymmetrical capacitor, wherein the dielectric material (3) may be made of one or more materials, placed or used in such a way as to have a uniform relative electrical permittivity gradient along the dielectric material (3), or to generate a relative electrical permittivity gradient along the dielectric material (3) in a given direction aligned with the direction of the force from asymmetric electric pulses.

10. The electromagnetic propulsion system, according to claim 6, wherein the at least one propulsion unit (7), is surrounded or protected, totally or partially, by dielectric and/or conductive, and/or magnetic shield (6), where shield (6) involves an object of interest selected from the group consisting of people, biological material, or nearby equipment, inside or outside the at least one first conductor (1), and/or the at least one second conductor (2), and/or the at least one propulsion unit (7); or where the propulsion units (7) are inserted inside a shield (6).

11. The electromagnetic propulsion system according to claim 1, wherein the at least one first conductors (1) and the at least one second conductors (2) are made of a material selected from the group consisting of a conductive, superconducting or semiconducting material, materials that generate superconductivity, non-conducting material, a paint, a film, magnetic particles, nanoparticles of carbon, graphene or other materials, with positive or negative permittivity or permeability.

12. The electromagnetic propulsion system, according to claim 6, wherein the dielectric material (3) is selected from the group consisting of: a solid, liquid or gaseous material, wherein the dielectric material (3) is pure or a symmetrical or asymmetrical mixture of several different dielectrics and optionally contains embedded in its interior, symmetrically or asymmetrically, conductive, or semiconducting, or non-conducting, or magnetic particles, or nanoparticles of positive or negative, linear or non-linear, permittivity or permeability, such as powder, or metallic, or magnetic, or semiconducting; wherein the dielectric material (3) can also be selected from piezoelectric materials, or pyroelectric materials, or ferroelectric materials, or metamaterials, or glasses, or quartz, or ceramics, or plastics, or other dielectric materials; where the dielectric material (3), the shield (6), and/or the at least one first conductor (1) and the at least one second conductor (2) are made of a material selected from the group consisting of metal matrix composite materials, ceramic matrix composite materials, matrix composite materials of carbon, composite materials of polymer matrices.

13. The electromagnetic propulsion system, according to claim 6, wherein the one or more power supplies (5) are selected from the group consisting of constant voltage or current, oscillating voltage or current, rectified oscillating voltage or current, pulsed voltage or current, wherein the pulses emitted by the power supply (5) are selected from the group consisting of symmetric or asymmetric pulses, pulses with symmetric or asymmetric time derivative of voltage V or electric field E, with asymmetric product V·∂V/∂t or E·∂E/∂t; wherein, as way of non-limiting examples of voltage waveforms to use we suggest using: a) unipolar, positive or negative, symmetric pulses with symmetric rise and fall times like rectified sinusoidal, or rectified square or rectified triangle or rectified symmetric ramp signals, or any other symmetric rectified pulse, or b) unipolar, positive or negative, asymmetric pulses with asymmetric rise and fall times like asymmetric ramps or asymmetric triangles, or asymmetric squares or asymmetric sinusoidal signals, or any other asymmetric rectified pulse; wherein, as way of non-limiting examples of available power supplies (5) to use we suggest using Marx generators, inductive voltage pulse generators, Tesla coils, unipolar waveform wave pulse generators, high voltage microwave generators with symmetric or asymmetric voltage pulses or rectified unipolar waveforms, bipolar high voltage power supply DC with switch (4) or with resistors having switches (4), or bipolar high voltage rectified or bipolar high voltage AC with DC unipolar, any high voltage DC power supply with switch (4) or with resistors having switches (4) among many other options; wherein the one or more power supplies (5) are optionally combined with switches (4), and are connected to one or more of the at least one first conductor (1), and/or one or more of the at least one second conductor (2), and/or shield (6).

14. The electromagnetic propulsion system, according to claim 7, characterized by the use independently or in conjunction, of at least one of the propulsion units (7) attached to the object (8) or to part of such object (8), distributed along its periphery, or inside or outside the object (8), wherein the at least one propulsion unit (7), is optionally movable and inclinable in any direction; wherein the object (8) is selected, in a non limiting way, from the group consisting of a spaceship, a road vehicle, a flying vehicle, a maritime ship, an underwater vehicle and a human suit.

15. An Electromagnetic Propulsion system, or inertia attenuator, or force field generator, according to claim 7, wherein there is used at least one of the propulsion units (7), or a single conductor (1) whole or segmented, placed on the surface or around the object (8), partially or completely, where at least one external conductor of propulsion unit (7) or at least one external single first conductor (1) is connected to one or more power supplies (5); where object (8) is moving or stationary; where propulsion or a force field is selectively applied to specific parts of the object (8) and its outside environment, depending on which first conductor (1) or propulsion unit (7) is electrically activated with electrical pulses where first conductor (1) is opaque or transparent and whole or segmented; where first conductor (1) may optionally be coated outside or inside by one or more dielectrics (3), or coated inside by shield (6).
